(19) United States
(12) Patent Application Publication
(10) Pub. No.: US 2022/0086749 A1
(43) Pub. Date: Mar. 17, 2022

(54) CELL SELECTION ON A RADIO LINK FAILURE IN WIRELESS RELAY NETWORKS

(71) Applicants: SHARP KABUSHIKI KAISH, Sakai City, Osaka (JP); FG Innovation Company Limited, Tuen Mun, New Territories (HK)

(72) Inventor: Atsushi ISHII, Vancouver, WA (US)

(21) Appl. No.: 17/423,838

(22) PCT Filed: Jan. 17, 2020
(86) PCT No.: PCT/JP2020/001606

§ 371 Date: Jul. 16, 2021

Related U.S. Application Data
(60) Provisional application No. 62/795,445, filed on Jan. 22, 2019.

(51) Int. Cl. H04W 48/20; H04W 24/02; H04W 40/22; H04L 12/705; H04W 40/36; H04W 48/02; H04W 36/08; H04W 36/00

(52) U.S. Cl. CPC H04W 48/20; H04W 24/02; H04W 40/22; H04L 45/18; H04W 84/22; H04W 48/02; H04W 36/08; H04W 36/00835; H04W 40/36

(57) ABSTRACT

An IAB node comprises receiver circuitry and processor circuitry. The receiver circuitry is configured to receive routing loop prevention information. The processor circuitry configured to perform a cell selection procedure using the routing loop prevention information and thereby avoid selecting a cell of a child or grandchild node. The routing loop prevention information may comprise configuration information, or alternatively may comprise system information that broadcasts, e.g., identifications of upstream nodes.

### CROSS REFERENCE

This Nonprovisional application claims priority under 35 U.S.C. § 119 on provisional Application No. 62/795,445 on Jan. 22, 2019, the entire contents of which are hereby incorporated by reference.

### TECHNICAL FIELD

The technology relates to wireless communications, and particularly to radio architecture and operation for resolving problematic conditions on wireless relay networks.

### BACKGROUND ART

A radio access network typically resides between wireless devices, such as user equipment (UEs), mobile phones, mobile stations, or any other device having wireless termination, and a core network. Example of radio access network types includes the GRAN, GSM radio access network; the GERAN, which includes EDGE packet radio services; UTRAN, the UMTS radio access network; E-UTRAN, which includes Long-Term Evolution; and g-UTRAN, the New Radio (NR).

A radio access network may comprise one or more access nodes, such as base station nodes, which facilitate wireless communication or otherwise provides an interface between a wireless terminal and a telecommunications system. A non-limiting example of a base station can include, depending on radio access technology type, a Node B (“NB”), an enhanced Node B (“eNB”), a home eNB (“HeNB”), a gNB (for a New Radio [“NR”] technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth generation system, e.g., the 5G System, also called “NR” or “New Radio”, as well as “NG” or “Next Generation”, is shown in FIG. 39, and is also described in 3GPP TS 38.300. The 5G NR network is comprised of NG RAN (Next Generation Radio Access Network) and 5GC (5G Core Network). As shown, NGRAN is comprised of gNBs (e.g., 5G Base stations) and ng-eNBs (i.e. LTE base stations). An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. A NG interface exists between 5GC and the base stations (i.e. gNB & ng-eNB). A gNB node provides NR user plane and control plane protocol terminations towards the UE, and is connected via the NG interface to the 5GC. The 5G NR (New Radio) gNB is connected to AMF (Access and Mobility Management Function) and UPF (User Plane Function) in 5GC (5G Core Network).

In some cellular mobile communication systems and networks, such as Long-Term Evolution (LTE) and New Radio (NR), a service area is covered by one or more base stations, where each of such base stations may be connected to a core network by fixed-line backhaul links (e.g., optical fiber cables). In some instances, due to weak signals from the base station at the edge of the service area, users tend to experience performance issues, such as: reduced data rates, high probability of link failures, etc. A relay node concept has been introduced to expand the coverage area and increase the signal quality. As implemented, the relay node may be connected to the base station using a wireless backhaul link.

In 3rd Generation Partnership Project (3GPP), the relay node concept for the fifth generation (5G) cellular system has been discussed and standardized, where the relay nodes may utilize the same 5G radio access technologies (e.g., New Radio (NR)) for the operation of services to User Equipment (UE) (access link) and connections to the core network (backhaul link) simultaneously. These radio links may be multiplexed in time, frequency, and/or space. This system may be referred to as Integrated Access and Backhaul (IAB).

Some such cellular mobile communication systems and networks may comprise IAB-donors and IAB-nodes, where an IAB-donor may provide interface to a core network to UEs and wireless backhauling functionality to IAB-nodes; and additionally, an IAB-node may provide IAB functionality combined with wireless self-backhauling capabilities. IAB-nodes may need to periodically perform inter-IAB-node discovery to detect new IAB-nodes in their vicinity based on cell-specific reference signals (e.g., Synchronization Signal and PBCH block SSB). The cell-specific reference signals may be broadcasted on a Physical Broadcast Channel (PBCH) where packets may be carried or broadcasted on the Master Information Block (MIB) section.

Demand for wireless traffic has increased significantly over time and IAB systems are expected to be reliable and robust against various kinds of possible failures. Considerations have been given for IAB backhaul design. In particular, to provide methods and procedures to address radio link failures on the backhaul link.

What is needed are methods, apparatus, and/or techniques to cope with unfavorable conditions or problems on a wireless backhaul link.

### SUMMARY OF INVENTION

In one example, a wireless relay node comprising: receiver circuitry configured to receive routing loop prevention information; processor circuitry configured to perform a cell selection procedure based on the routing loop prevention information; wherein the routing loop prevention information comprises configuration parameters to be used to avoid selecting a cell of a child or grandchild node during the cell selection procedure.

In one example, a donor node comprising: processor circuitry configured to include routing loop prevention information in a message; transmitter circuitry configured to transmit the routing loop prevention information message to a wireless relay node; wherein the routing loop prevention information comprises configuration parameters to be used by the wireless relay node during a cell selection procedure to avoid selecting a cell served by the wireless relay node's child or grandchild node.

In one example, a method for a wireless relay node comprising: receiving routing loop prevention information; performing a cell selection procedure based on the routing loop prevention information; wherein the routing loop prevention information comprises configuration parameters to be used to avoid selecting a cell of a child or grandchild node during the cell selection procedure.

In one example, a method for a donor node comprising: including routing loop prevention information in a message; transmitting the routing loop prevention information message to a wireless relay node; wherein the routing loop prevention information comprises configuration parameters to be used by the wireless relay node during a cell selection procedure to avoid selecting a cell served by the wireless relay node's child or grandchild node.

### BRIEF DESCRIPTION OF DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view illustrating a mobile network infrastructure using 5G signals and 5G base stations.

FIG. 2 is a diagrammatic view depicting an example of functional block diagrams for the IAB-donor and the IAB-node.

FIG. 3 is a diagrammatic view illustrating Control Plane (C-Plane) and User Plane (U-Plane) protocols among the UE, IAB-nodes, and IAB-donor.

FIG. 4 is a functional block diagram of an example protocol stack configuration for the U-Plane.

FIG. 5A depicts a functional block diagram of an example protocol stack configuration for the C-Plane between an IAB-node connected to an IAB-donor.

FIG. 5B depicts a functional block diagram of an example configuration of the C-Plane protocol stack for an IAB-node connected to another IAB-node which is connected to an IAB-donor.

FIG. 5C depicts a functional block diagram of an example configuration of the C-Plane protocol stack for a UE's RRC signaling.

FIG. 6A depicts an example message sequence for an IAB-node to establish an RRC connection, followed by F1-AP* connection.

FIG. 6B depicts an example message sequence for IAB-node to establish an RRC connection with an IAB-donor, followed by the F1 setup procedure.

FIG. 7 is a diagrammatic view of an example scenario where an IAB-node detects a Radio Link Failure (RLF) on the upstream link to its parent node.

FIG. 8 illustrates an example flow of information transmit/receive and/or processing by a UE and/or IAB-node connected to a set of IAB-nodes in communication with an IAB-donor, for processing a notification of an RLF.

FIG. 9A illustrates an example flow of information transmit/receive and/or processing by a UE and/or IAB-node connected to a set of IAB-nodes in communication with an IAB-donor, based on receiving an Upstream RLF notification.

FIG. 9B illustrates another example flow of information transmit/receive and/or processing by a UE and/or IAB-node connected to a set of IAB-nodes in communication with an IAB-donor, based on not having received an Upstream RLF notification.

FIG. 10 is a diagrammatic view illustrating an example of a radio protocol architecture for the control and user planes in a mobile communications network.

FIG. 11 is a diagrammatic view showing another example telecommunications system in which a conditional autonomous handover may be performed for resolving a wireless link backhaul condition.

FIG. 12 is a diagrammatic view showing an example, non-limiting more detailed implementation of at least portions of the system of FIG. 11.

FIG. 13 is a flowchart showing example, non-limiting, basic acts or steps that may be performed by a wireless access node of FIG. 11.

FIG. 14 is a flowchart showing example, non-limiting, basic acts or steps that may be performed by a child node of FIG. 11.

FIG. 15 depicts example, basic, representative acts or steps of a message flow for the system scenario shown in FIG. 11.

FIG. 16 is a diagrammatic view showing another example telecommunications system in wherein a wireless link backhaul condition may be resolved when redundant links are utilized.

FIG. 17 is a diagrammatic view showing an example, non-limiting more detailed implementation of at least portions of the system of FIG. 16.

FIG. 18 is a flowchart showing example, non-limiting, basic acts or steps that may be performed by a wireless access node of FIG. 16.

FIG. 19 is a flowchart showing example, non-limiting, basic acts or steps that may be performed by a child node of FIG. 16.

FIG. 20A depicts example, basic, representative acts or steps of a message flow for a first example system scenario shown in FIG. 16.

FIG. 20B depicts example, basic, representative acts or steps of a message flow for a first example system scenario shown in FIG. 16.

FIG. 21 is a diagrammatic view showing another example telecommunications system wherein a routing loop may occur upon cell selection.

FIG. 22A depicts example, basic, representative acts or steps of a message flow in a situation in which an IAB node of FIG. 21 may recover from a broken upstream link by an RRC reestablishment procedure with a first parent IAB node.

FIG. 22B depicts example, basic, representative acts or steps of a message flow in a situation in which an IAB node of FIG. 21 may recover from a broken upstream link by an RRC reestablishment procedure with a first parent IAB node.

FIG. 23 is a diagrammatic view showing another example telecommunications system, and particularly an example telecommunications system wherein generic routing loop prevention information is used to address a potential routing loop problem.

FIG. 24 is a flowchart showing example, non-limiting, basic acts or steps that may be performed by a wireless access donor node of FIG. 23.

FIG. 25 is a flowchart showing example, non-limiting, basic acts or steps that may be performed by a non-donor Integrated Access and Backhaul (IAB) node of FIG. 23.

FIG. 26A is a diagrammatic view showing an example implementation of the generic telecommunications system of FIG. 23 wherein the routing loop prevention information comprises configuration information, e.g., configuration parameter(s), generated by a donor Integrated Access and Backhaul (IAB) node.

FIG. 26B is a diagrammatic view showing an example implementation of the generic telecommunications system of FIG. 23 wherein the routing loop prevention information comprises configuration information, e.g., configuration parameter(s), generated by a network server entity.

FIG. 27 is a diagrammatic view of an example message flow including a RRCReconfiguration message for sending a whitelist or blacklist of configuration parameter(s).

FIG. 28 is a flowchart showing example, representative acts or steps which may be performed by the JAB node of FIG. 26A.

FIG. 29 is a flowchart showing example, representative acts or steps which may be performed by the wireless access donor node of FIG. 26A.

FIG. 30 is a flowchart showing example, representative acts or steps which may be performed by the wireless access donor node of FIG. 26B.

FIG. 31 is a flowchart showing example, representative acts or steps which may be performed by the network entity FIG. 26B.

FIG. 32 is a schematic view of an IAB node which further comprises a configuration parameter(s) validity timer.

FIG. 33 is a diagrammatic view showing an example implementation of the generic telecommunications system of FIG. 23 wherein, as routing loop prevention information, an Integrated Access and Backhaul (IAB) node broadcasts system information which announces parent nodes.

FIG. 34 is a diagrammatic view illustrating a mode of operation of a telecommunications network that includes Integrated Access and Backhaul (IAB) nodes that broadcasts system information which announces parent nodes in the manner of FIG. 33.

FIG. 35 is a diagrammatic view showing an example implementation of the generic telecommunications system of FIG. 23 wherein, as routing loop prevention information, an Integrated Access and Backhaul (IAB) node broadcasts system information which announces parent nodes, and wherein a routing loop prevention information generator takes the form of a parent node identifications generator.

FIG. 36 is a flowchart showing example, representative acts or steps which may be performed by the wireless access donor node of FIG. 33-FIG. 35.

FIG. 37 is a flowchart showing example, representative acts or steps which may be performed by the wireless access donor node of FIG. 33-FIG. 35.

FIG. 38 is a diagrammatic view showing example elements comprising electronic machinery which may comprise a wireless terminal, a radio access node, and a core network node according to an example embodiment and mode.

FIG. 39 is a diagrammatic view of overall architecture for a 5G New Radio system.

### DESCRIPTION OF EMBODIMENTS

In one of its example aspects, the technology disclosed herein concerns a node of an Integrated Access and Backhaul (IAB) network and method of operating the same. In an example embodiment and mode the IAB node comprises receiver circuitry and processor circuitry. The receiver circuitry is configured to receive routing loop prevention information. The processor circuitry configured to perform a cell selection procedure using the routing loop prevention information and thereby avoid selecting a cell of a child or grandchild node.

In another of its example aspects, the technology disclosed herein concerns a donor node of an Integrated Access and Backhaul (IAB) network and method of operating the same. In an example embodiment and mode the donor IAB node comprises processor circuitry and transmitter circuitry. The processor circuitry is configured to include routing loop prevention information for a cell selection procedure in a routing loop prevention information message. The transmitter circuitry is configured to transmit the routing loop prevention information message to a wireless relay node.

In some example embodiments and modes described herein, the routing loop prevention information comprises configuration information, while in other example embodiments and modes the routing loop prevention information comprises system information that broadcasts, e.g., identifications of upstream nodes.

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology.

As used herein, the term “telecommunication system” or “communications system” can refer to any network of devices used to transmit information. A non-limiting example of a telecommunication system is a cellular network or other wireless communication system.

As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

Any reference to a “resource” herein means “radio resource” unless otherwise clear from the context that another meaning is intended. In general, as used herein a radio resource (“resource”) is a time-frequency unit that can carry information across a radio interface, e.g., either signal information or data information. An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two dimensional grid represents a symbol (e.g., an OFDM symbol on downlink (DL) from node to wireless terminal; an SCFDMA symbol in an uplink (UL) frame from wireless terminal to node). Each row of the grid represents a subcarrier. A resource element (RE) is the smallest time-frequency unit for downlink transmission in the subframe. That is, one symbol on one sub-carrier in the sub-frame comprises a resource element (RE) which is uniquely defined by an index pair (k,l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural sub-carriers and plural symbols (e.g., plural resource elements (RE)) and is called a resource block (RB). A resource block may comprise, for example, 84 resource elements, i.e., 12 subcarriers and 7 symbols, in case of normal cyclic prefix A mobile network used in wireless networks may be where the source and destination are interconnected by way of a plurality of nodes. In such a network, the source and destination may not be able to communicate with each other directly due to the distance between the source and destination being greater than the transmission range of the nodes. That is, a need exists for intermediate node(s) to relay communications and provide transmission of information. Accordingly, intermediate node(s) may be used to relay information signals in a relay network, having a network topology where the source and destination are interconnected by means of such intermediate nodes. In a hierarchical telecommunications network, the backhaul portion of the network may comprise the intermediate links between the core network and the small subnetworks of the entire hierarchical network. Integrated Access and Backhaul (IAB) Next generation NodeB use 5G New Radio communications such as transmitting and receiving NR User Plane (U-Plane) data traffic and NR Control Plane (C-Plane) data. Both, the UE and gNB may include addressable memory in electronic communication with a processor. In one embodiment, instructions may be stored in the memory and are executable to process received packets and/or transmit packets according to different protocols, for example, Medium Access Control (MAC) Protocol and/or Radio Link Control (RLC) Protocol.

In some aspects of the embodiments for handling of radio link failures in wireless relay networks, disclosed is a Mobile Termination (MT) functionality—typically provided by the User Equipment (UE) terminals—that may be implemented by Base Transceiver Stations (BTSs or BSs) nodes, for example, IAB nodes. In one embodiment, the MT functions may comprise common functions such as: radio transmission and reception, encoding and decoding, error detection and correction, signaling, and access to a SIM.

In a mobile network, an IAB child node may use the same initial access procedure (discovery) as an access UE to establish a connection with an IAB node/donor or parent-thereby attaching to the network or camping on a cell. In one embodiment, Radio Resource Control (RRC) protocol may be used for signaling between 5G radio network and UE, where RRC may have at least two states (e.g., RRC_IDLE and RRC_CONNECTED) and state transitions. The RRC sublayer may enable establishing of connections based on the broadcasted system information and may also include a security procedure. The U-Plane may comprise of PHY, MAC, RLC and PDCP layers.

Embodiments of the present system disclose methods and devices for an IAB-node to inform child nodes and/or UEs of upstream radio conditions and accordingly, the term IAB-node may be used to represent either a parent IAB-node or a child IAB-node, depending on where the IAB-node is in the network communication with the IAB-donor which is responsible for the physical connection with the core network. Embodiments are disclosed where an IAB-node (child IAB-node) may follow the same initial access procedure as a UE, including cell search, system information acquisition, and random access, in order to initially set up a connection to a parent IAB-node or an IAB-donor. That is, when an IAB base station (eNB/gNB) needs to establish a backhaul connection to, or camp on, a parent IAB-node or an IAB-donor, the IAB-node may perform the same procedures and steps as a UE, where the IAB-node may be treated as a UE but distinguished from a UE by the parent IAB-node or the IAB-donor.

In the disclosed embodiments for handling radio link failures in wireless relay networks, MT functionality—typically offered by a UE—may be implemented on an IAB-node. In some examples of the disclosed systems, methods, and device embodiments, consideration may be made in order for a child IAB-node to monitor a radio condition on a radio link to a parent IAB-node—where the parent IAB-node may itself be a child IAB-node in communication with an IAB-donor.

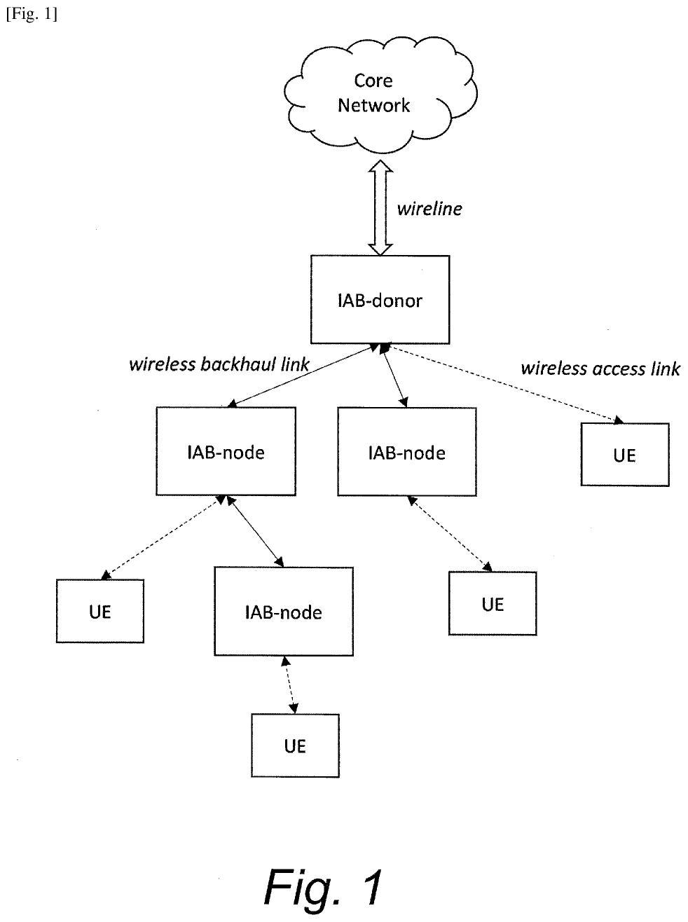

With reference to FIG. 1, the present embodiments include a mobile network infrastructure using 5G signals and 5G base stations (or cell stations). Depicted is a system diagram of a radio access network utilizing IAB nodes, where the radio access network may comprise, for example, one IAB-donor and multiple IAB-nodes. Different embodiments may comprise different number of IAB-donor and IAB-node ratios. Herein, the IAB nodes may be referred to as IAB relay nodes. The IAB-node may be a Radio Access Network (RAN) node that supports wireless access to UEs and wirelessly backhauls the access traffic. The JAB-donor may be a RAN node which may provide an interface to the core network to UEs and wireless backhauling functionality to IAB nodes. An IAB-node/donor may serve one or more IAB nodes using wireless backhaul links as well as UEs using wireless access links simultaneously. Accordingly, network backhaul traffic conditions may be implemented based on the wireless communication system to a plurality of IAB nodes and UEs.

With further reference to FIG. 1, a number of UEs are depicted as in communication with IAB nodes, for example, IAB nodes and IAB donor node, via wireless access link. Additionally, the IAB-nodes (child nodes) may be in communication with other IAB-nodes and/or an IAB-donor (all of which may be considered IAB parent nodes) via wireless backhaul link. For example, a UE may be connected to an IAB-node which itself may be connected to a parent IAB-node in communication with an IAB-donor, thereby extending the backhaul resources to allow for the transmission of backhaul traffic within the network and between parent and child for integrated access. The embodiments of the system provide for capabilities needed to use the broadcast channel for carrying information bit(s) (on the physical channels) and provide access to the core network.

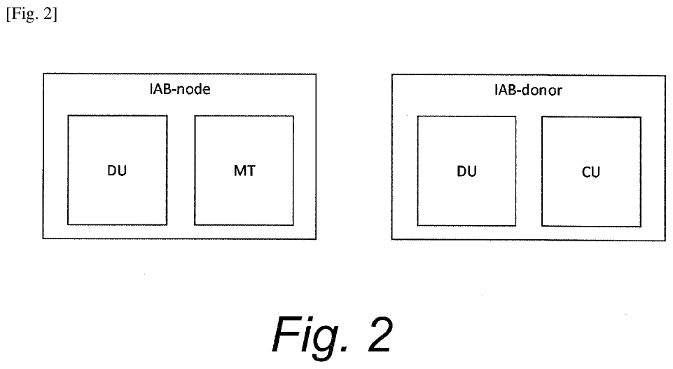

FIG. 2 depicts an example of functional block diagrams for the IAB-donor and the IAB-node (see FIG. 1). The IAB-donor may comprise at least one Central Unit (CU) and at least one Distributed Unit (DU). The CU is a logical entity managing the DU collocated in the IAB-donor as well as the remote DUs resident in the IAB-nodes. The CU may also be an interface to the core network, behaving as a RAN base station (e.g., eNB or gNB). In some embodiments, the DU is a logical entity hosting a radio interface (backhaul/access) for other child IAB-nodes and/or UEs. In one configuration, under the control of CU, the DU may offer a physical layer and Layer-2 (L2) protocols (e.g., Medium Access Control (MAC), Radio Link Control (RLC), etc.) while the CU may manage upper layer protocols (such as Packet Data Convergence Protocol (PDCP), Radio Resource Control (RRC), etc.). An IAB-node may comprise DU and Mobile-Termination (MT) functions, where in some embodiments the DU may have the same functionality as the DU in the IAB-donor, whereas MT may be a UE-like function that terminates the radio interface layers. As an example, the MT may function to perform at least one of: radio transmission and reception, encoding and decoding, error detection and correction, signaling, and access to a SIM.

Embodiments include a mobile network infrastructure where a number of UEs are connected to a set of IAB-nodes and the IAB-nodes are in communication with each other for relay and/or an IAB-donor using the different aspects of the present embodiments. In some embodiments, the UE may communicate with the CU of the IAB-donor on the C-Plane using RRC protocol and in other embodiments, using Service Data Adaptation Protocol (SDAP) and/or Packet Data Convergence Protocol (PDCP) radio protocol architecture for data transport (U-Plane) through NR gNB. In some embodiments, the DU of the IAB-node may communicate with the CU of the IAB-donor using 5G radio network layer signaling protocol: F1 Application Protocol (F1-AP*) which is a wireless backhaul protocol that provides signaling services between the DU of an IAB-node and the CU of an IAB-donor. That is, as further described below, the protocol stack configuration may be interchangeable, and different mechanism may be used.

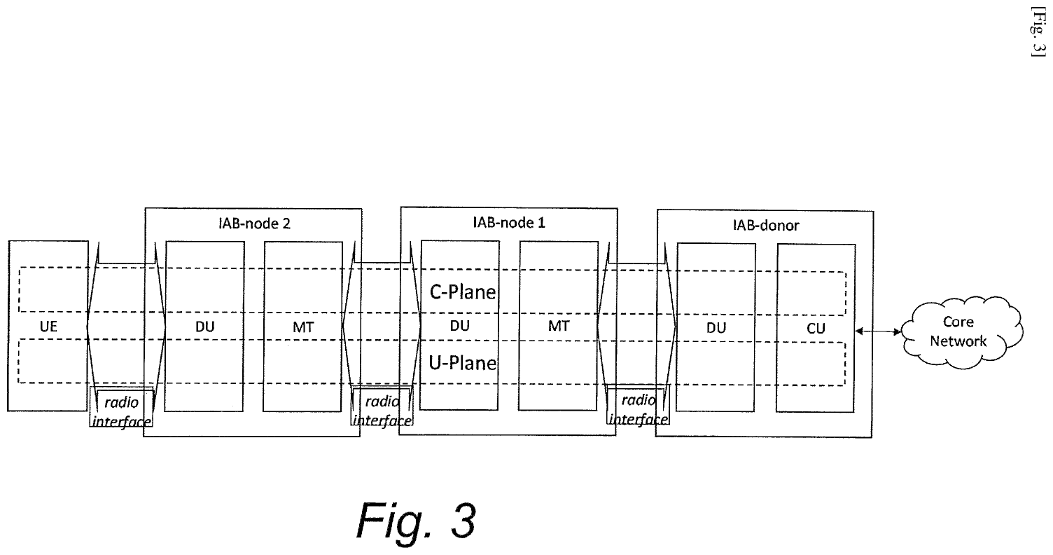

As illustrated by the diagram shown in FIG. 3, the protocols among the UE, IAB-nodes, and IAB donor are grouped into Control Plane (C-Plane) and User Plane (U-Plane). C-Plane carries control signals (signaling data), whereas the U-Plane carries user data. FIG. 3 shows an example of the embodiment where there are two IAB-nodes, IAB-node 1 and IAB-node 2, between the UE and the IAB-donor (two hops). Other embodiments may comprise a network with a single hop or multiple hops where there may be more than two IAB-nodes present.

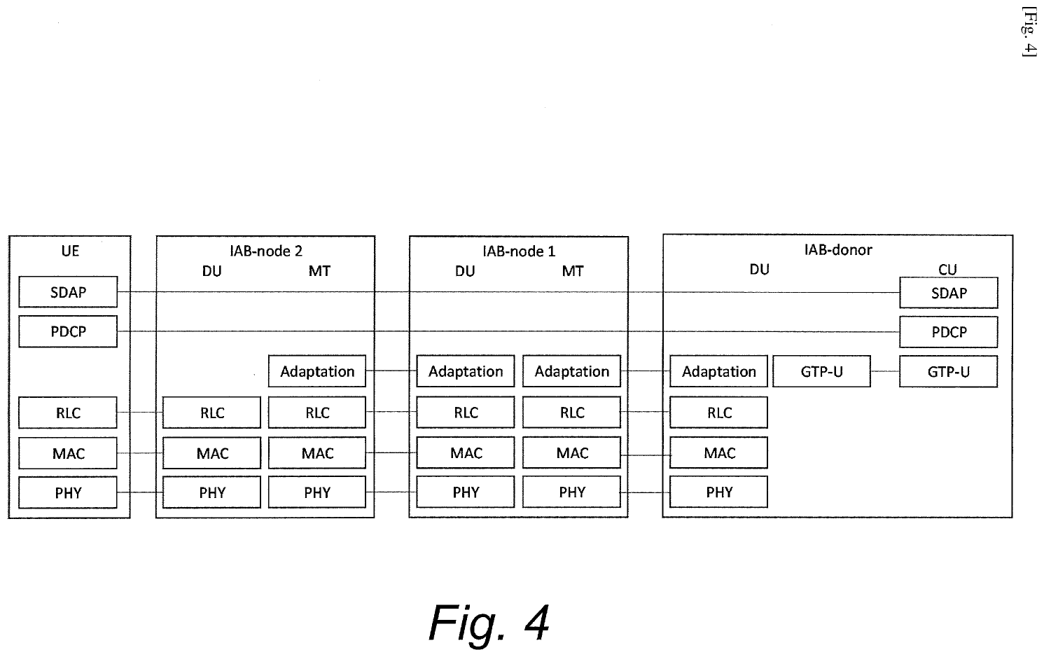

FIG. 4 depicts a functional block diagram of an example protocol stack configuration for the U-Plane, the stack comprising Service Data Protocol (e.g., SDAP, 3GPP TS 38.324) which may carry user data (e.g., via IP packets). In one embodiment, the SDAP runs on top of PDCP (3GPP TS 38.323) and the L2/Physical layers. In one embodiment, an Adaptation Layer (e.g. Backhaul Adaptation Protocol, BAP) is introduced between the IAB-node and the IAB-node/donor, where the Adaptation Layer carries relay-specific information, such as IAB-node/donor addresses, QoS information, UE identifiers, and potentially other information. In this embodiment, RLC (3GPP TS 38.322) may provide reliable transmission in a hop-by-hop manner while PDCP may perform end-to-end (UE-CU) error recovery. GTP-U (GPRS Tunneling Protocol User Plane) may be used for routing user data between CU and DU inside the IAB-donor.

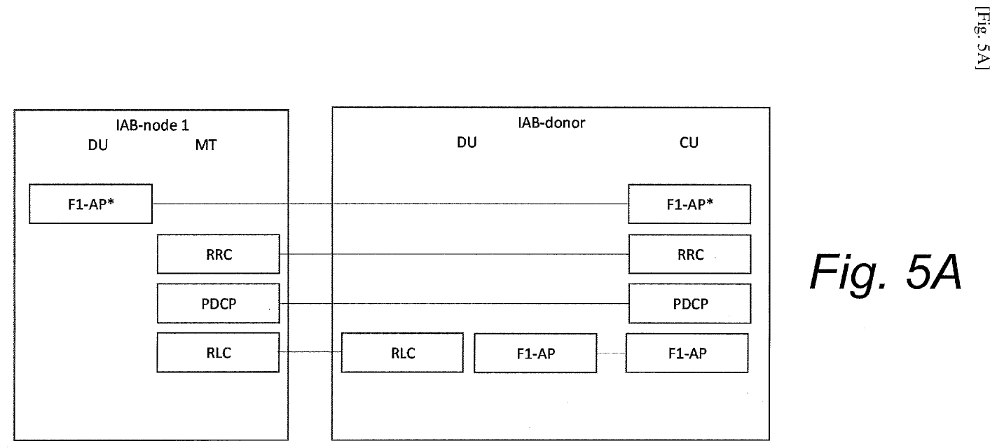

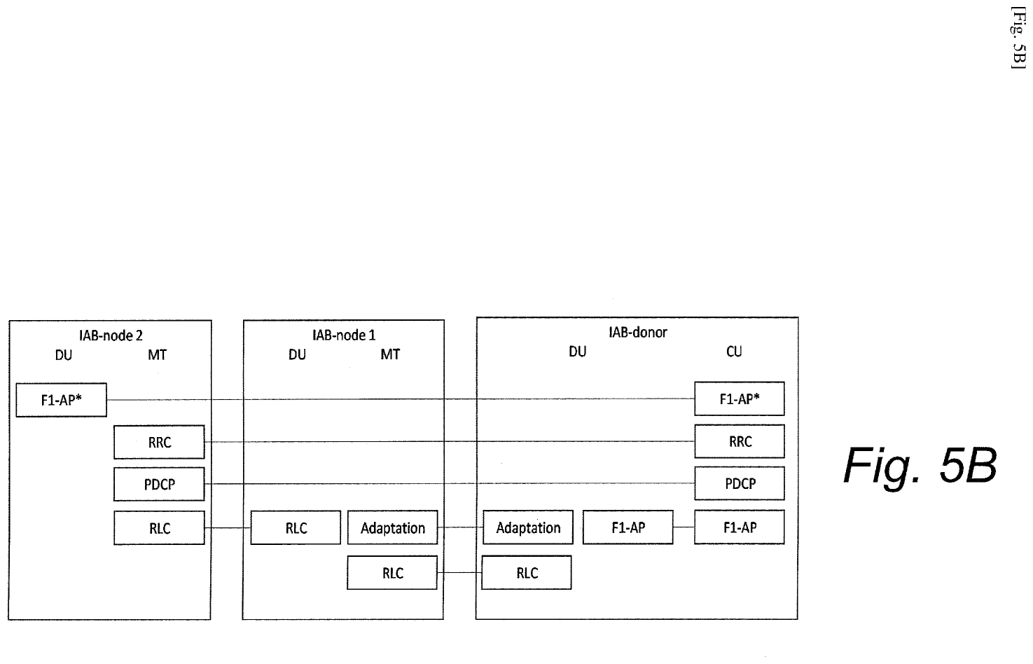

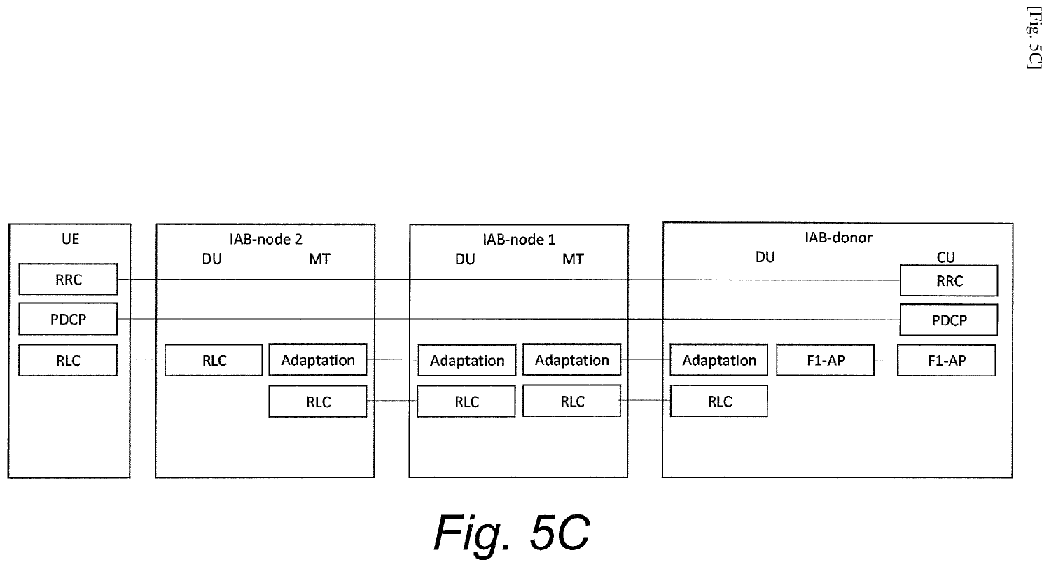

FIG. 5A is a functional block diagram of an example protocol stack configuration for the C-Plane between an IAB-node (IAB-node 1) directly connected to the IAB-donor (via a single hop). In this embodiment, the MT component of IAB-node 1 may establish an RRC connection with the CU component of the IAB-donor. In parallel, RRC may be used for carrying another signaling protocol in order for CU/IAB-donor to control the DU component resident in the IAB-node 1. In one embodiment, such a signaling protocol may be referred to as F1 Application Protocol* (F1-AP*), either the protocol referred as F1-AP specified in 3GPP TS 38.473 or a protocol based on the F1-AP with potential extended features to accommodate wireless backhauls (the original F1-AP is designed for wirelines). In other embodiments, F1-AP may be used for CU-DU connection inside the IAB-donor. It is assumed that below RLC, MAC/PHY layers are shared with the U-Plane.

FIG. 5B depicts a functional block diagram of an example configuration of the C-Plane protocol stack for IAB-node 2, an IAB-node connected to the aforementioned IAB-node 1 (2 hops). In one embodiment, it may be assumed that the IAB-node 1 has already established RRC/F1-AP* connections with the IAB-donor as shown in FIG. 5A. In IAB-node 1 the signaling bearer for IAB-node 2 RRC/PDCP may be carried by the Adaptation Layer to the IAB-donor. Similar to FIG. 5A, the F1-AP* signaling is carried by the RRC of IAB-node 2.

FIG. 5C depicts yet another functional block diagram of an example configuration of the C-Plane protocol stack for UE's RRC signaling under the 2-hop relay configuration shown in FIG. 5B. Accordingly, the UE having an MT component and functionality, via the C-Plane, may be connected to the CU of the IAB-donor. Though traffic is routed through IAB-node 2 and IAB-node 1, as depicted, the two nodes are passive nodes in that the data is passed to the next node(s) without manipulation. That is, data is transmitted by the UE to the node it is connected to, e.g., IAB-node 2, and then IAB-node 2 transmits the data to the node that is connected to, e.g., IAB-node 1, and then IAB-node 1 transmits the data (without manipulation) to the IAB-donor.

FIGS. 5A, 5B, and 5C illustrate that the MT of each IAB-node or UE has its own end-to-end RRC connection with the CU of the IAB-donor. Likewise, the DU of each IAB-node has an end-to-end F1-AP* connection with the CU of the IAB-donor. Any IAB nodes present between such end points transparently convey RRC or F1-AP signaling traffic.

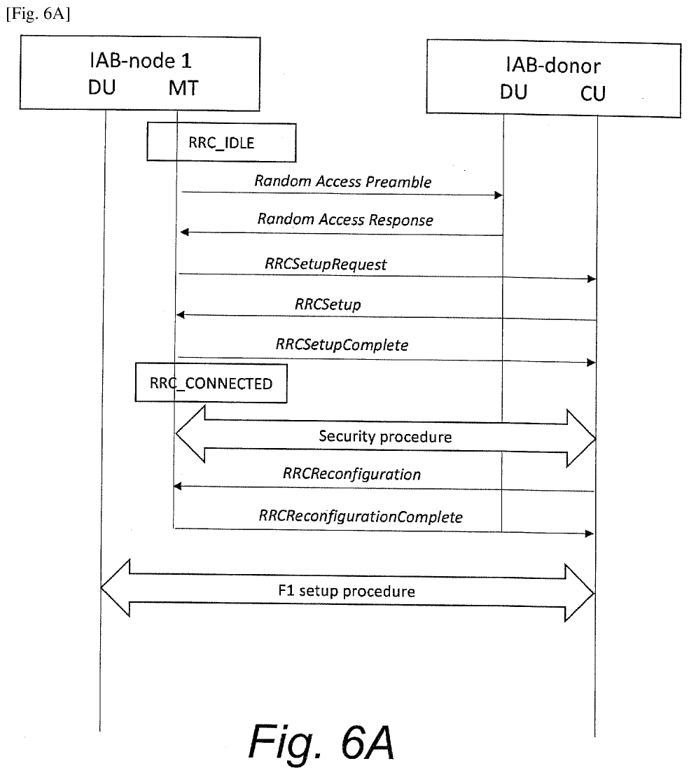

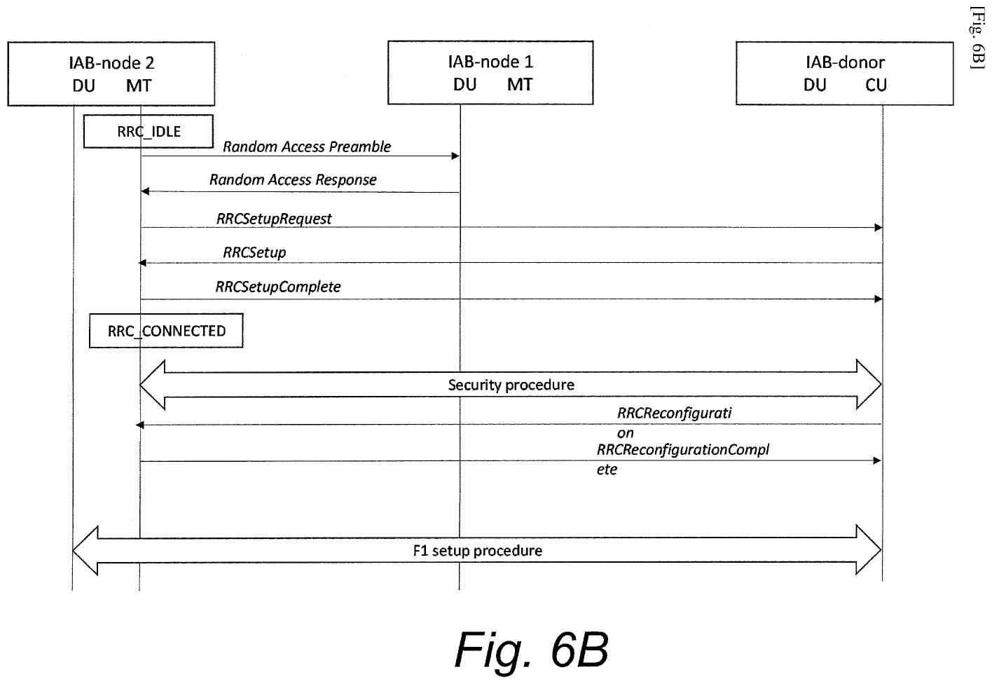

FIGS. 6A and 6B are diagrams of an example flow of information transmit/receive and/or processing by IAB-node(s) and an IAB-donor according to aspects of the present embodiments.

FIG. 6A depicts an example message sequence for IAB-node 1 to establish an RRC connection, followed by F1-AP* connection. It is assumed that IAB-node 1 has been pre-configured (or configured by the network) with information that instructs how to select a cell served by the IAB-donor. As shown in the figure, IAB-node 1—in an idle state (RRC_IDLE)—may initiate an RRC connection establishment procedure by sending Random Access Preamble to the IAB-donor, which may be received and processed by the DU of the IAB-donor. Upon successful reception of Random Access Response from the IAB-donor, IAB-node 1 may send a RRCSetupRequest, followed by reception of an RRCSetup and transmission of RRCSetupComplete. At this point of the message sequence, the IAB-node 1 may enter a connected state (RRC_CONNECTED) with the IAB-donor, and may proceed with a security procedure to configure encryption/integrity protection features. The CU of the IAB-donor may further send an RRCReconfiguration to IAB-node 1, which may comprise configuration parameters to configure radio bearers (e.g., data radio bearers (DRBs) and signaling radio bearers (SRBs)). In some embodiments, the RRCReconfiguration is sent to modify an RRC connection and establish Radio Connection between a UE and the network, however, in the present embodiment, the RRCReconfiguration may also be sent to configure a connection between an IAB-node and the network. RRC Connection Reconfiguration messages may be used to, for example, establish/modify/release Radio Bearers, and/or perform handover, etc. In one embodiment, any of the RRC messages transmitted from IAB-node 1 may include information identifying the IAB-node 1 as an IAB-node (not as a UE). For example, the Donor CU may be configured with a list of node identities (e.g., IMSI or S-TMSI) that may be allowed to use the service from the donor. The information may be used by the CU in the subsequence operations, for example, to distinguish a UE from an IAB-node.

As described above, following the RRC connection establishment procedure, the DU of IAB-node 1 and IAB-donor may proceed with F1 setup procedure using the F1-AP* protocol, which may activate one or more cells served by the DU of IAB-node 1—thereby allowing other IAB nodes and/or UEs to camp on the cell. In this procedure, the Adaptation Layer for IAB-node 1 and IAB-donor may be configured and activated as well.

FIG. 6B depicts an example message sequence or flow of information for IAB-node 2 to establish an RRC connection with IAB-donor, followed by the F1 setup procedure. It is assumed in this embodiment that IAB-node 1 has already performed the process disclosed in FIG. 6A to establish an RRC and F1-AP* connection. Referring back to FIG. 3, the IAB-node 2 shown in communication via the radio interface with IAB-node 1, may be also depicted in FIG. 6B as a child node of IAB-node 1 according to aspects of the present embodiments.

It should be understood that upon or after establishing the RRC/F1-AP connection the IAB-donor may acquire knowledge of the IAB-node location within the relay network topology. In one configuration, this may be achieved by intermediate IAB-nodes relaying identifications of nodes located in its downstream to its upstream nodes.

Due to the nature of wireless communications, the wireless backhaul links are susceptible to be deteriorated or broken at any time. In aspects of the present embodiments, the MT part of an IAB-node may constantly monitor the quality of the radio link and/or signal quality on the upstream of the IAB-node, where the radio link may be to a parent IAB node/donor of the IAB-node. If radio problems cannot be recovered in a designated duration, the MT may declare Radio Link Failure (RLF), meaning a loss of communication link may have occurred or signal strength is weak to continue (e.g., below a threshold).

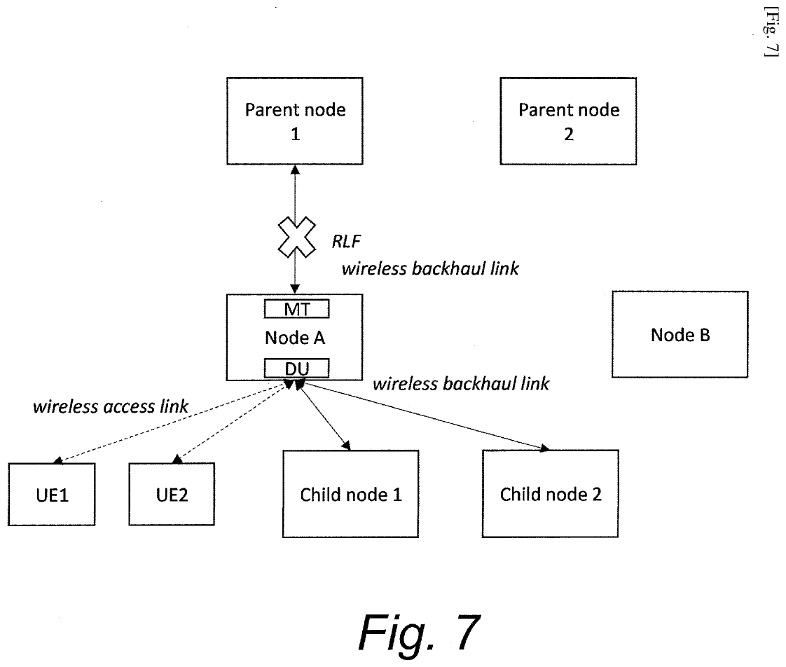

FIG. 7 shows an example diagram of a scenario where an IAB-node (Node A) detects RLF on the upstream link to its parent node (Parent node 1). In some embodiments, the MT component of Node A may need to find another parent that is visible from the node. In this case, the MT component may perform a cell selection procedure, and if a suitable cell (Parent node 2) is successfully found, the Node A may then proceed with an RRC reestablishment procedure with the suitable cell (Parent node 2). It should be noted that Node A in this scenario needs to find a cell served by either an IAB-node or an IAB-donor (i.e., non-IAB-capable cells are not suitable). In one embodiment, a cell served by either an IAB-node or an IAB-donor may broadcast (e.g., in the system information, such as MIB, system information block type 1 (SIB1) or any of the other SIBs) a state, e.g., via a flag, as an indication indicating the IAB capability, which may further comprise an indication of the IAB functionality, a node type (IAB-node or IAB-donor), a hop count and/or the current state of the connectivity to the parent node. Alternatively, or in parallel, Node A may have been pre-configured or configured by the network with a list of IAB-capable cell identifications.

While Node A is trying to find a new suitable IAB-capable serving cell, the child IAB nodes (Child node 1 and Child node 2) and/or UEs (UE1 and UE2) may still be in connected mode with Node A. If Node A successfully recovers from the RLF before expiration of a pre-configured (or network-configured) period of time, the child nodes and/or the UEs may not be aware of the RLF. However, in the scenario where Node A fails or has failed to recover from the RLF in a timely manner (e.g., before expiration of a pre-configured/network-configured period of time), not only may these child nodes/UEs suffer discontinuity of service, but also all the nodes/UEs in the downstream may also suffer discontinuity of service.

The present embodiments disclose systems, methods, and device where an IAB-node may inform connected nodes (child nodes) or UEs, of the upstream radio conditions. In some embodiments, the upstream radio condition information may enable the child nodes or UEs to decide to stay connected with the IAB-node or to look for another node to connect to.

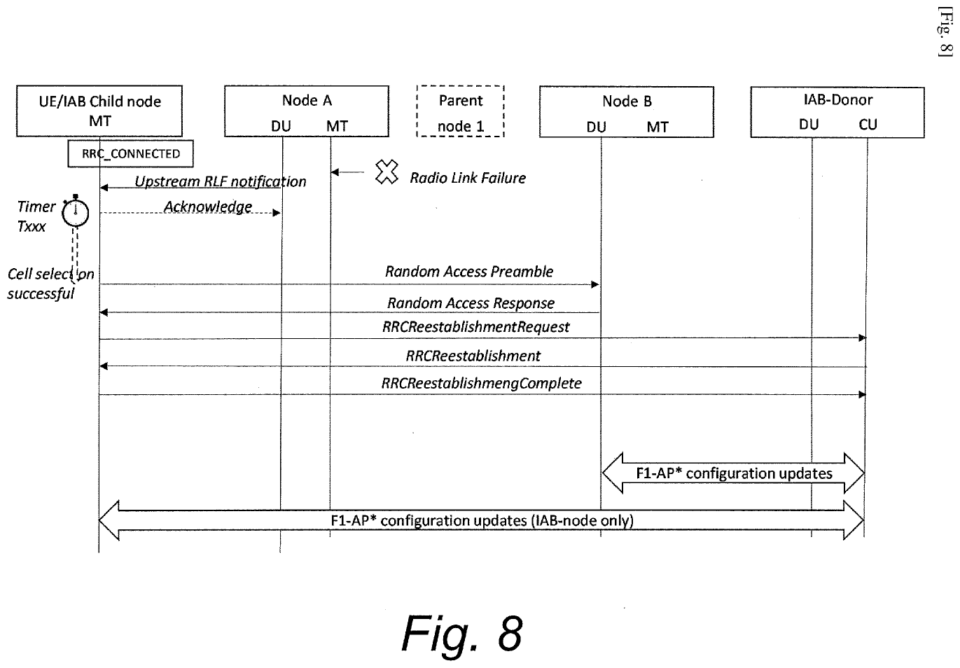

FIG. 8 shows an example scenario for Upstream RLF notification, a notification of an RLF, sent from a node (Node A) and detected on the node's upstream, to the child nodes and/or the directly connected UEs. In one embodiment, upon receiving the notification, each of the child nodes and/or UEs may perform cell selection and, if successful, proceed to RRC reestablishment. As shown in FIG. 8, each of the child nodes and/or UEs, after a successful selection to a new node (Node B), may start the reestablishment procedure through Node B. That is, once a successful selection is made, the child nodes and/or UEs may transmit Random Access Preamble/Response messages, followed by RRCReestablishmentRequest and subsequent messages as illustrated in FIG. 8.

In one embodiment, Upstream RLF notification may be carried by the Adaptation Layer (e.g., a header part or a message body of the Adaptation Layer protocol). In an alternate embodiment, or in addition to, the notifications may be carried by the RLC sublayer, MAC, or a physical layer signaling (e.g., PDCCH). Additionally or alternatively, the notifications may be broadcasted via system information (e.g., MIB, SIB1 or any of the other SIBs) or transmitted in a dedicated manner.

Accordingly, in one embodiment, RRC resident in each of the child nodes and/or UEs may perform cell selection upon receiving a notification indicating the reception of the Upstream RLF notification from lower layers. In the present embodiments, this may be performed even if the radio link to the parent node remains in good condition. The node and/or UE may then start a timer, timer Txxx (e.g., T311 specified in 3GPP TS 38.331), based on the received notification, and upon selecting a suitable cell while timer Txxx is running, the node and/or UE may stop timer Txxx and initiate transmission of RRCReestablishmentRequest to the IAB-donor.

Once the RRC connection is reestablished, the CU of the IAB-donor may update the F1-AP* configurations in Node B as well as the child IAB-node that initiated the RRC reestablishment. In the scenario where the connecting device is a UE, F1-AP* configuration updates are not needed as they do not have the F1-AP* interface. Accordingly, the updated configuration from the IAB-donor may be used to reconfigure the routing topology which was modified or changed due to the RLF.

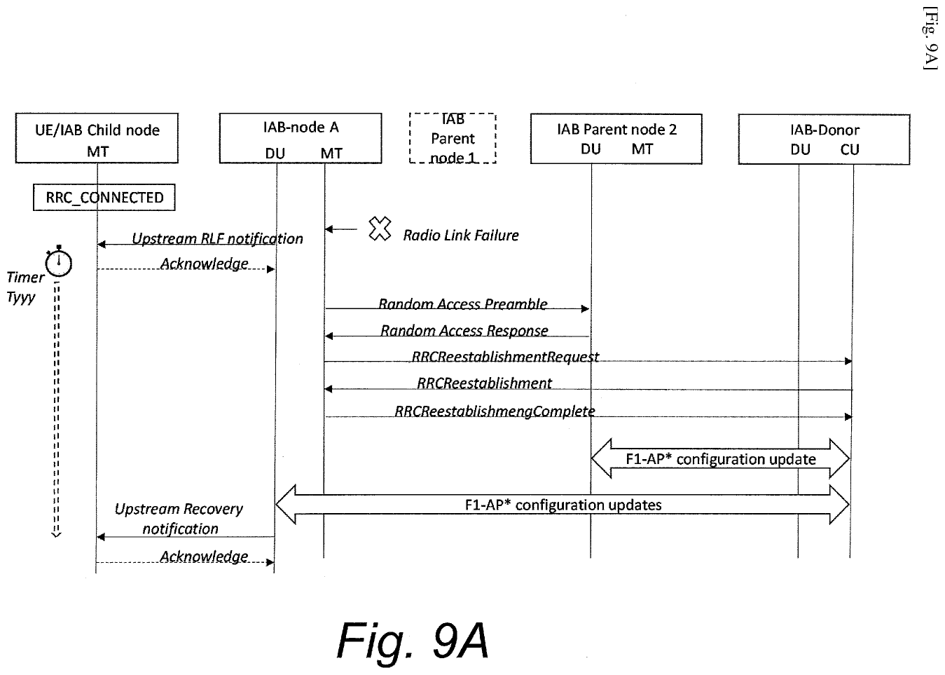

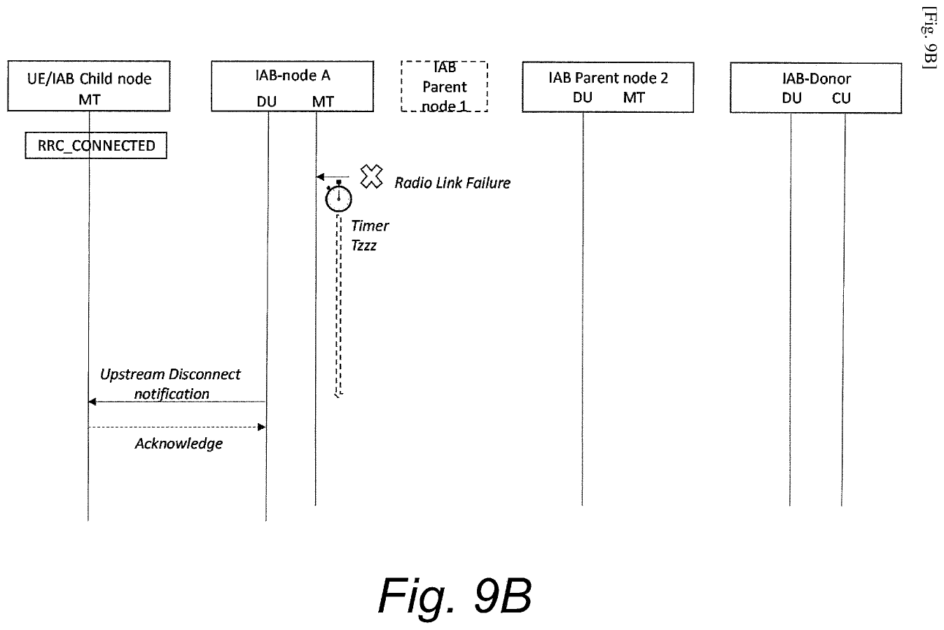

FIG. 9A shows another scenario where the child nodes and/or UEs may start a timer, for example, timer Tyyy, based on receiving an Upstream RLF notification. While the timer Tyyy is running, Node A may attempt to recover the upstream link by performing cell selection. In the scenario depicted in FIG. 9, Node A has successfully found a new parent node (Parent node 2) and may initiate the RRC reestablishment procedure. Node A, based on receiving F1-AP* configuration update from the CU of the IAB-donor, may transmit/send Upstream Recovery notification—a notification indicating that the upstream is recovered—to the child IAB-node and/or the UEs. If timer Tyyy has not expired yet, the child IAB-node and/or the UEs that receive the notification may stop timer Tyyy and stay connected with Node A. If the timer expires before receiving Upstream Recovery notification, the child IAB-node and/or the UEs may perform cell selection/RRC reestablishment as shown in FIG. 8. In one embodiment, the timer value/configuration may be pre-configured. In another embodiment, the timer value/configuration may be configured by the parent node (e.g., Parent node 1) via a dedicated signaling or via a broadcast signaling (e.g., system information, such as MIB, SIB1 or any of the other SIBs).

Similar to the previous scenario, in one embodiment, the Upstream RLF notification may be carried by the Adaptation Layer, RLC, MAC, or a physical layer signaling. Additionally, the notifications may be broadcasted via system information (e.g., MIB, SIB1 or any of the other SIBs) or transmitted in a dedicated manner.

In yet another embodiment for this scenario, RRC resident in each of the child nodes and/or UEs may start timer Tyyy upon receiving Upstream RLF notification from the lower layers. If the node and/or UE receive a notification indicating the reception of the Upstream RLF notification from lower layers while timer Tyyy is running, the node and/or UE may stop timer Tyyy. If timer Tyyy expires, the node and/or UE may then start timer Txxx and upon selecting a suitable cell while the timer is running, the node and/or UE may stop the timer and initiate transmission of RRCReestablishmentRequest.

FIG. 9B shows yet another scenario where Node A may start a timer Tzzz upon detecting an RLF. In this scenario, Node A may or may not send the aforementioned Upstream RLF notification to the child IAB-nodes and/or UEs. While the timer Tzzz is running, Node A may attempt to recover the upstream link by performing cell selection. In the scenario depicted in FIG. 9B, at the timer Tzzz expiry (cell selection failure), Node A may send a notification (e.g. Upstream Disconnect notification) to the child IAB-nodes/UEs notifying the unsuccessful RLF recovery. In this case, the child IAB-nodes/UEs that receive the notification may start the aforementioned timer Txxx and initiate the cell selection procedure as shown in FIG. 8. The notification may be carried by the Adaptation Layer, RLC, MAC, or a physical layer signaling, in a broadcast or a dedicated manner. In one embodiment, the timers Txxx and Tzzz may be the same timer or share same configurations. In another embodiment, the timers Txxx and Tzzz may be different timers or differently configured.

Additionally, notifications that an IAB-node provides to its downstream (children/UEs) may not be limited to RLF or RLF recovery. In some embodiments, the IAB-node may inform child nodes and/or UEs of the signal quality (e.g., Reference Signal Received Power (RSRP), Reference Signal Received Quality (RSRQ)), error rates, and/or any other types of measurements that indicate the radio condition of the upstream. In this case, IAB-nodes and/or UEs may be pre-configured or configured by the network with conditions for initiating cell selection/reestablishment. The notifications may be carried by the Adaptation Layer, RLC, MAC, or a physical layer signaling, in a broadcast or a dedicated manner.

In one embodiment, upon receiving one of the notifications from the parent node, the IAB-node and/or UE may send back or respond with an acknowledgement to the parent node, as shown in FIG. 8, FIGS. 9A and 9B.

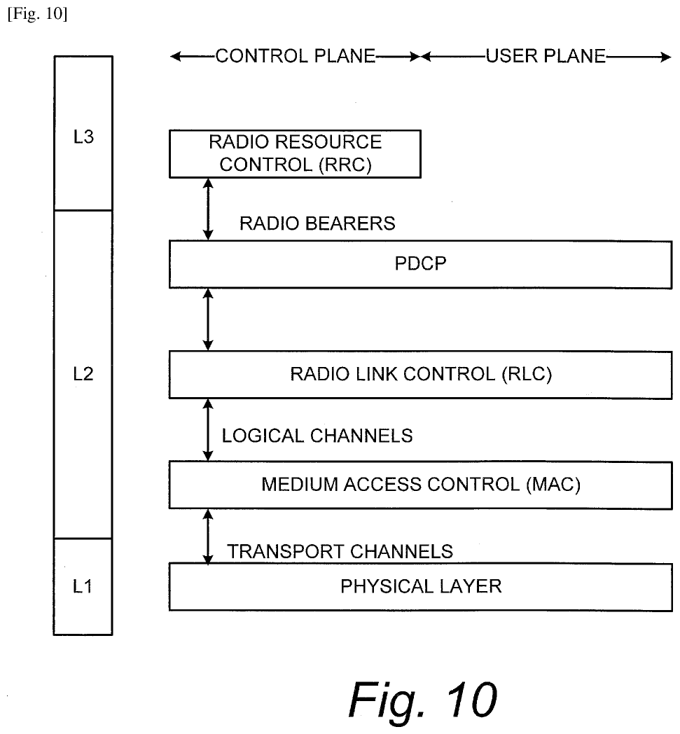

FIG. 10 is a diagram illustrating an example of a radio protocol architecture for the control and user planes in a mobile communications network. The radio protocol architecture for the UE and/or the gNodeB may be shown with three layers: Layer 1, Layer 2, and Layer 3. Layer 1 (L1 layer) is the lowest layer and implements various physical layer signal processing functions. Layer 2 (L2 layer) is above the physical layer and responsible for the link between the UE and/or gNodeB over the physical layer. In the user plane, the L2 layer may include a media access control (MAC) sublayer, a radio link control (RLC) sublayer, and a packet data convergence protocol (PDCP) sublayer, which are terminated at the gNodeB on the network side. Although not shown, the UE may have several upper layers above the L2 layer including a network layer (e.g., IP layer) that is terminated at the PDN gateway on the network side, and an application layer that is terminated at the other end of the connection (e.g., far end UE, server, etc.). The control plane also includes a radio resource control (RRC) sublayer in Layer 3 (L3 layer). The RRC sublayer is responsible for obtaining radio resources (i.e., radio bearers) and for configuring the lower layers using RRC signaling between the IAB-nodes and/or the UE and an IAB-donor.

Addressing Backhaul Conditions with Autonomous Handover

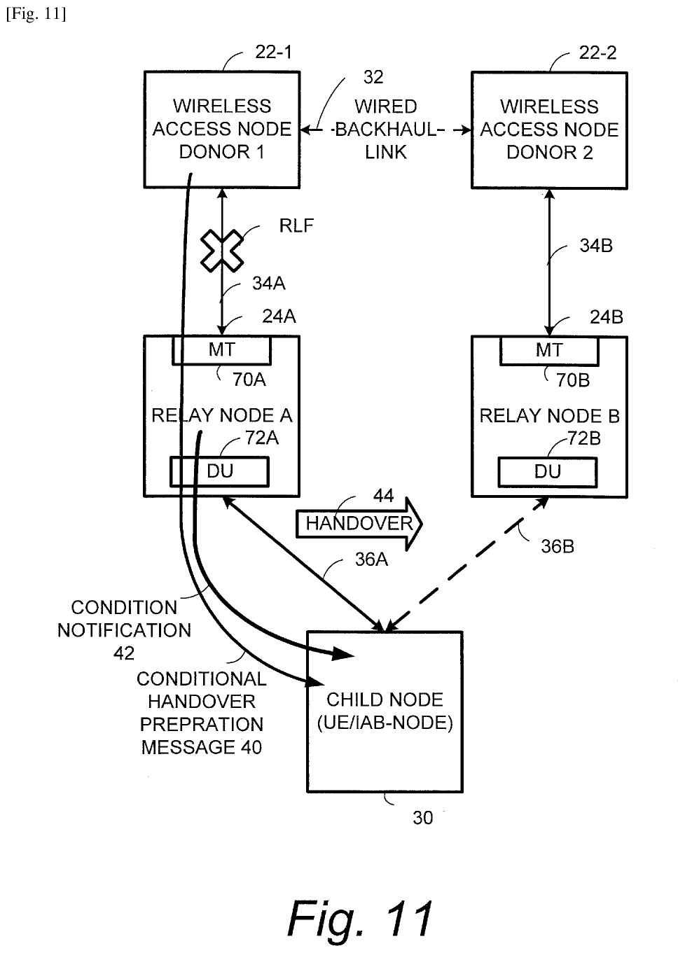

FIG. 11 shows yet another example diagram of a telecommunications system 20 comprising wireless access node 22-1, also known as Donor node 1; wireless access node 22-2, also known as Donor node 2; IAB-node 24A, also known as Node A or relay node A; IAB-node 24B, also known as Node B or relay node B; and child node 1, also known as child node 30. The child node 30 may be, for example, a user equipment, UE, or Integrated Access and Backhaul (IAB) node, as previously described. The wireless access node 22-1 and wireless access node 22-2 may be connected by a wired backhaul link 32. The other elements of FIG. 11 may be connected by wireless backhaul links, e.g., the wireless access node 22-1 may be connected by wireless backhaul link 34A to IAB-node 24A; the wireless access node 22-2 may be connected by wireless backhaul link 34B to IAB-node 24B; the IAB-node 24A may be connected by wireless backhaul link 36A to child node 30; and the IAB-node 24B may be connected by 36B to child node 30.

The example embodiments and modes of FIG. 11-FIG. 15 concern addressing problematic conditions on a wireless backhaul link using an autonomous handover. In general terms, the wireless access node 22-1 generates and sends to child node 30 a message which comprises information configured to facilitate a conditional handover of the wireless terminal. As used herein, the terms “handover” and “handoff” may be used interchangeably, and generally involve transfer of a connection or communication, at least partially, from one node or set of nodes to another node. Although the message may be of any appropriate type and bear any suitable name, in an example embodiment and mode described herein the message is a reconfiguration message and, for sake of illustration, is arbitrarily and not exclusively known, and shown in FIG. 11, as the conditional handover preparation message 40. The information comprising such message, e.g., the conditional handover preparation message 40, includes at least one identity of a target cell and one or more conditions which at least partially enable the wireless terminal to perform a conditional handover autonomously. In some configurations, the identity of a target cell may comprise one of or a combination of; a physical cell identity (PCI), CellIdentity (a cell identifier to unambiguously identify a cell within a PLMN), a PLMN-identity, a tracking area identity, and a RAN area code. As understood herein, the one or more conditions including a reception of a notification from the wireless relay node, e.g., from IAB-node 24A. Such notification is also known herein and shown in FIG. 11 as condition notification 42, and may be notification of a problematic condition on a wireless backhaul link. Upon reception of the condition notification 42, the child node 30 may perform an autonomous handover, depicted as event 44 in FIG. 11. The performance of the autonomous handover 44 is based on, e.g., enabled by using at least, the information provided in the conditional handover preparation message 40.

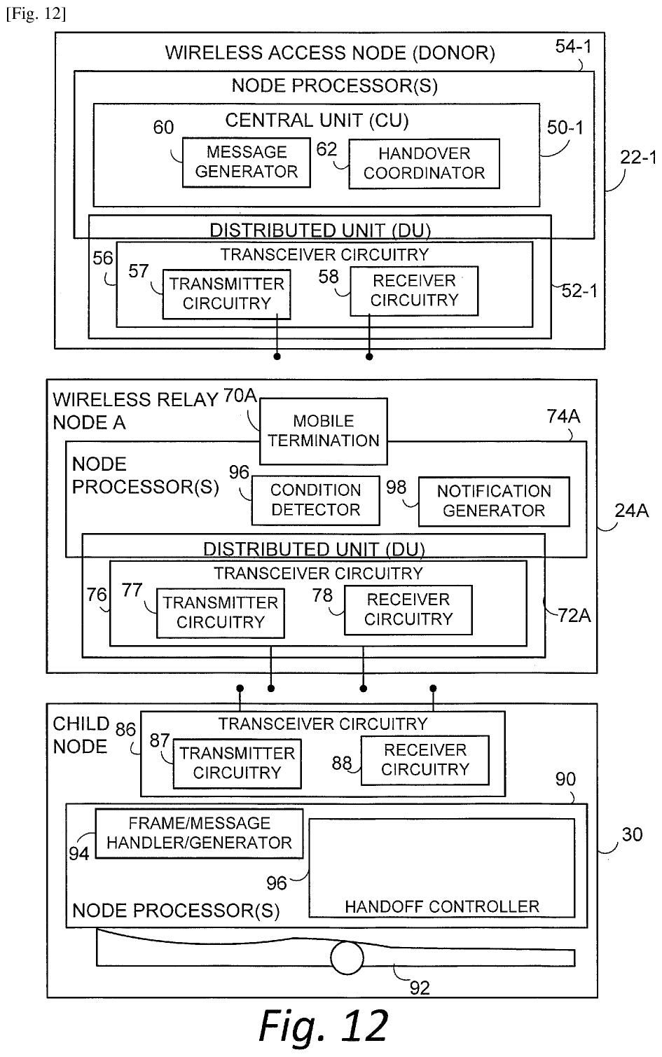

Various components and functionalities of the nodes shown in FIG. 11 are further shown in FIG. 12. FIG. 12 shows wireless access node 22-1 as comprising central unit 50-1 and distributed unit 52-1. The central unit 50-1 and distributed unit 52-1 may be realized by, e.g., be comprised of or include, one or more processor circuits, e.g., node processor(s) 54-1. The one or more node processor(s) 54-1 may be shared by central unit 50-1 and distributed unit 52-1, or each of central unit 50-1 and distributed unit 52-1 may comprise one or more node processor(s) 54-1. Moreover, central unit 50-1 and distributed unit 52-1 may be co-located at a same node site, or alternatively one or more distributed units 52-2 may be located at sites remote from central unit 50-1 and connected thereto by a packet network. The distributed unit 52-1 may comprise transceiver circuitry 56, which in turn may comprise transmitter circuitry 57 and receiver circuitry 58. The transceiver circuitry 56 includes antenna(e) for the wireless transmission. Transmitter circuitry 57 includes, e.g., amplifier(s), modulation circuitry and other conventional transmission equipment. Receiver circuitry 58 comprises, e.g., amplifiers, demodulation circuitry, and other conventional receiver equipment.

As further shown in FIG. 12, node processor(s) 54-1 of wireless access node 22-1 may comprise message generator 60 and handover coordinator 62. The message generator 60 serves to generate, e.g., the conditional handover preparation message 40 as described herein. As mentioned above, the conditional handover preparation message 40 includes information comprising at least one identity of a target cell and one or more conditions for the wireless terminal performing the conditional handover autonomously. The handover coordinator 62 serves to communicate with the target cell, e.g., with another node which may be involved in the handover, so that suitable information and preparation can be obtained for the handover. In the example scenario described herein, the target cell will be a cell served by wireless access node 22-2.

As shown in FIG. 12 the IAB-node 24A, also known as wireless relay node 24A, in an example embodiment and mode comprises relay node mobile termination unit 70A and relay node distributed unit 72A. The relay node mobile termination unit 70A and relay node distributed unit 72A may be realized by, e.g., by comprised of or include, one or more processor circuits, e.g., relay node processor(s) 74A. The one or more relay node processor(s) 74A may be shared by relay node mobile termination unit 70A and relay node distributed unit 72A, or each of relay node mobile termination unit 70A and relay node distributed unit 72A may comprise one or more relay node processor(s) 74A. The relay node distributed unit 72A may comprise transceiver circuitry 76, which in turn may comprise transmitter circuitry 77 and receiver circuitry 78. The transceiver circuitry 76 includes antenna(e) for the wireless transmission. Transmitter circuitry 77 may include, e.g., amplifier(s), modulation circuitry and other conventional transmission equipment. Receiver circuitry 78 may comprise, e.g., amplifiers, demodulation circuitry, and other conventional receiver equipment.

FIG. 12 further shows that IAB-node 24A may comprise radio condition detector 80 and notification generator 82. Both condition detector 80 and notification generator 82 may be realized or comprised by relay node processor(s) 74. The notification generator 82 serves to generate the condition notification 42, based on a condition detected by condition detector 80.

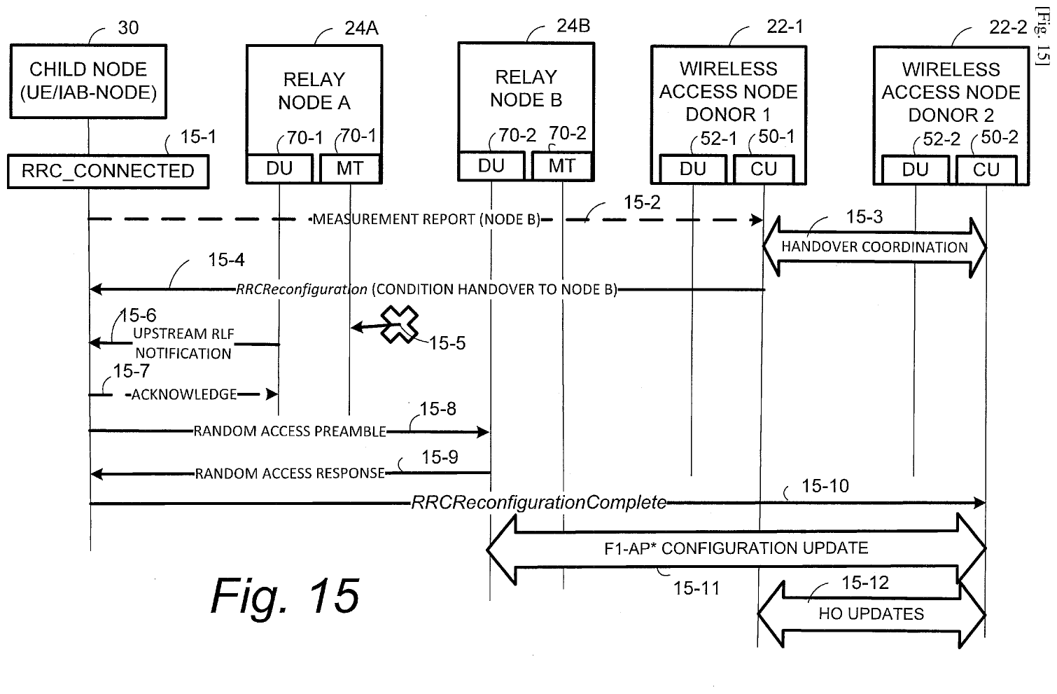

It should be understood that, although not illustrated in FIG. 12, the wireless access node 22-2 and IAB-node 24B of FIG. 11 and of FIG. 15 may have similar components and functionalities as the wireless access node 22-1 and IAB-node 24A, respectively, but with differently numbered/alphabetized suffixes denoting comparable components.

FIG. 12 shows child node 30 as comprising, in an example, non-limiting embodiment and mode, transceiver circuitry 86. The transceiver circuitry 86 in turn may comprise transmitter circuitry 87 and receiver circuitry 88. The transceiver circuitry 76 includes antenna(e) for the wireless transmission. Transmitter circuitry 77 may include, e.g., amplifier(s), modulation circuitry and other conventional transmission equipment. Receiver circuitry 78 may comprise, e.g., amplifiers, demodulation circuitry, and other conventional receiver equipment. FIG. 12 further shows child node 30, which (as indicated before) may be a user equipment or Integrated Access and Backhaul (IAB) node, as also comprising node processor circuitry, e.g., one or more node processor(s) 90, and interfaces 92, including one or more user interfaces. Such user interfaces may serve for both user input and output operations, and may comprise (for example) a screen such as a touch screen that can both display information to the user and receive information entered by the user. The user interface 48 may also include other types of devices, such as a speaker, a microphone, or a haptic feedback device, for example.

In an example, non-limiting embodiment and mode shown in FIG. 12, the child node 30 may include frame/message generator/handler 94 and handover controller 96. As is understood by those skilled in the art, in some telecommunications system messages, signals, and/or data are communicated over a radio or air interface using one or more “resources”, e.g., “radio resource(s)”. The frame/message generator/handler 94 serves to handle messages, signals, and data received from other nodes, including but not limited to the conditional handover preparation message 40 and condition notification 42 described herein.

In a most basic example embodiment and mode, a wireless access node of the technology disclosed herein transmits a message which comprises information configured to facilitate a conditional handover of the wireless terminal, the information comprising at least one identity of a target cell and one or more conditions for the wireless terminal performing the conditional handover autonomously, the conditions including a reception of a notification from the wireless relay node. In a most basic example embodiment and mode of the technology disclosed herein, the wireless terminal, e.g., child node 30, receives such message.

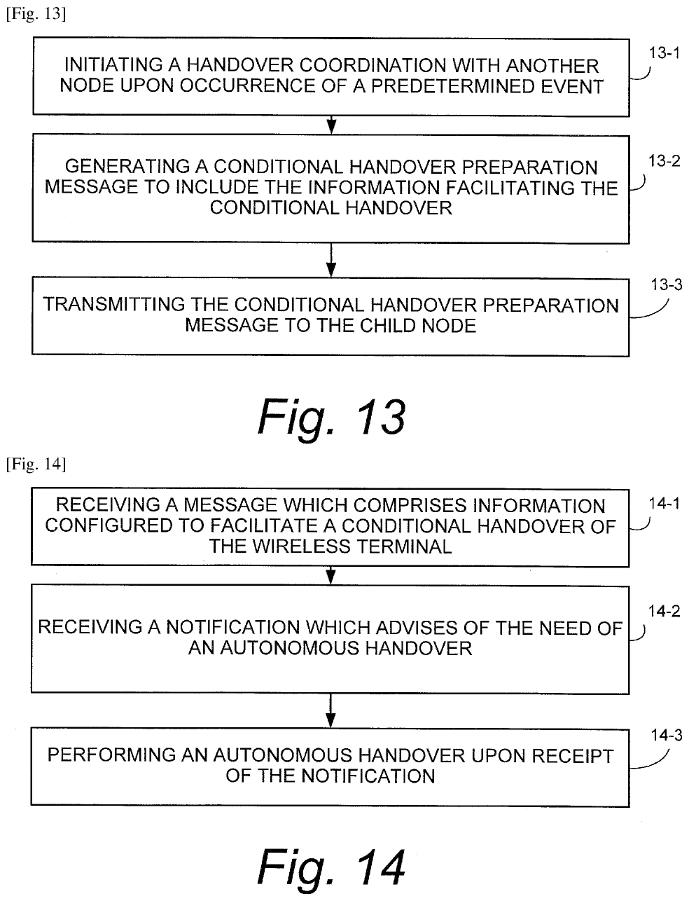

Beyond the basic example embodiment and mode mentioned above, FIG. 13 shows further example, optional, non-limiting, basic acts or steps that may be performed by the wireless access node 22-1 of FIG. 11 and FIG. 12. Act 13-1 comprises initiating a handover coordination with another node upon occurrence of a predetermined event. In the example scenario described herein, the other node to be involved in the handover is wireless access node 22-2. The handover coordination of act 13-1 may be performed by handover coordinator 62, which works through a wired backhaul link interface to wireless access node 22-2. The predetermined event may be, for example, receipt of a measurement report from the wireless terminal, e.g., from child node 30, including a measurement regarding a signal received by the wireless terminal from another node, such as wireless access node 22-2. Act 13-2 comprises generating the conditional handover preparation message 40 to include the information facilitating the conditional handover 44. The conditional handover preparation message 40 may be generated, e.g., by message generator 60 of node processor(s) 54-1. Act 13-3 comprises sending or transmitting the conditional handover preparation message to child node 30, e.g., over the wireless backhaul links 34A and 36A and thus via IAB-node 24A.

Beyond the basic example embodiment and mode mentioned above, FIG. 14 shows further example, optional, non-limiting, basic acts or steps that may be performed by child node 30 of FIG. 11 and FIG. 12. Act 14-1 comprises receiving a message which comprises information configured to facilitate a conditional handover of the wireless terminal. Such message may be, for example, the conditional handover preparation message 40 described herein, which comprises at least one identity of a target cell and one or more conditions for the wireless terminal performing the conditional handover autonomously. Act 14-2 comprises receiving the condition notification 42 from an appropriate node, such as IAB-node 24A, which advises of the possible need of an autonomous handover. Act 14-3 comprises, upon receipt of the condition notification 42, performing an autonomous handover 44 to another node, e.g., to wireless access node 22-2 through IAB-node 24B.

In an example scenario shown in FIG. 11, IAB-node 22A, also known as Node A or wireless access node 22A, may detect a radio condition, such as a radio link failure, RLF, on the upstream link to its parent node, e.g. wireless access node 22-1 or Donor 1. In the example scenario of FIG. 11, the Child Node 30, which may be an IAB-node or an UE, was configured by the donor-node wireless access node 22-1 with a conditional handover, e.g., conditional handover preparation message 40 which may be a reconfiguration with sync, in advance, which allows the child node 30 to autonomously perform a handover to a designated cell when one or more conditions configured by the RRC of the Donor 1 are satisfied. In some configurations, the conditions may include reception of some of the aforementioned notifications from a parent node, such as Upstream RLF notification. When such conditions are met, the Child Node 1, e.g., child node 30, may start accessing the designated cell (e.g. Node B/Donor 2, also called IAB-node 24B/wireless access node 22-2) and perform a handover procedure. In one example embodiment and mode, the Donor nodes 1 and 2 may be physically collocated or even the same entity. In another example embodiment and mode, these two donor nodes, e.g., wireless access node 22-1 and wireless access node 22-2, may be separate nodes, mutually connected by a wired backhaul link (as shown in FIG. 11). It is assumed that prior to providing the configuration for the conditional handover to Child node 30, the two donor nodes wireless access node 22-1 and wireless access node 22-2 may perform negotiations/coordination with regard to the handover, e.g., act 11-3, described above.

FIG. 15 depicts an example message flow for the scenario shown in FIG. 11. In the situation of FIG. 15, the child node 30 is in connected mode as shown by act 15-1. As act 15-3 the currently serving donor node, Donor 1 or wireless access node 22-1, may start a handover coordination with a node serving a potential target cell, e.g., Donor 2 or wireless access node 22-2. The coordination of act 15-3 may comprise sharing of identifications of the Child Node 1, e.g., child node 30; security parameters; and radio link configurations. As shown in FIG. 15, the coordination of act 15-3 may be triggered by act 15-2, e.g., receipt of a measurement report(s) transmitted by the Child Node 1, wherein the child node 30 reports sufficient signal quality observed from the Node B, e.g., from IAB-node 24B.

After the coordination of act 15-3 is completed, as act 15-4 the Child Node 30 (in the RRC_CONNECTED state, as indicated by act 15-1) may receive the conditional handover preparation message 40. In an example embodiment and mode, the conditional handover preparation message 40 may be a RRCReconfiguration message comprising potential target cells, e.g. the cell served by Node B or IAB-node 24B, and one or more conditions for an autonomous handover. In the example flow of FIG. 15, the conditions may include a reception of the Upstream RLF notification. The other non-limiting examples of conditions may include or comprise signal quality thresholds for the downlink signals from the currently serving node, e.g., Node A=IAB-node 24A), as well as some of the other aforementioned notifications, such as Upstream Disconnect notification.

In the example flow shown in FIG. 15, as act 15-5 the Node A, e.g., IAB-node 24A, may detect an RLF on the upstream link, e.g., on wireless backhaul link 32. The condition on the wireless backhaul link 32 may be detected by the condition detector 80 of IAB-node 24A. The Node A may then send the Upstream RLF notification 42 to its child nodes/UEs, including the Child node 30. The condition notification 42 may be generated by notification generator 82. As optional act 15-7, Child node 30 may send back an acknowledgement. Moreover, due to the configured conditions, as act 15-8 the child node 30 may initiate a conditional handover to the configured target cell, e.g., in the example scenario, the cell served by IAB-node 24B, by performing a random access procedure. The random access procedure in which child node 30 participates comprises, as act 15-8, sending a Random Access Preamble message to IAB-node 24B and, as act 15-9, receiving a Random Access Response message from IAB-node 24B. Act 15-10 comprises the child node 30 sending a RRCReconfigurationComplete message to the donor of the target cell, e.g., Donor 2=wireless access node 22-2 via Node B=IAB-node 24B. As act 15-11 wireless access node 22-2 may use F1-AP* to update the routing configurations at the Node B for the Child Node 1, e.g., at IAB-node 24B for child node 30, and as act 15-12 may interact with wireless access node 22-1 to report the completion of the conditional handover. The wireless access node 22-1 may then release the resources saved for child node 30.

Accordingly, in the example embodiment and mode of FIG. 11-FIG. 15, an IAB-node or a UE may be configured with a conditional handover with conditions, comprising a reception of a notification representing the radio condition of the upstream radio link of the parent node and at least one identification of a target node. Upon receiving such a notification, the IAB-node or the UE may then perform an autonomous handover to the cell served by the target node.

Addressing Backhaul Conditions Involving Redundant Connections

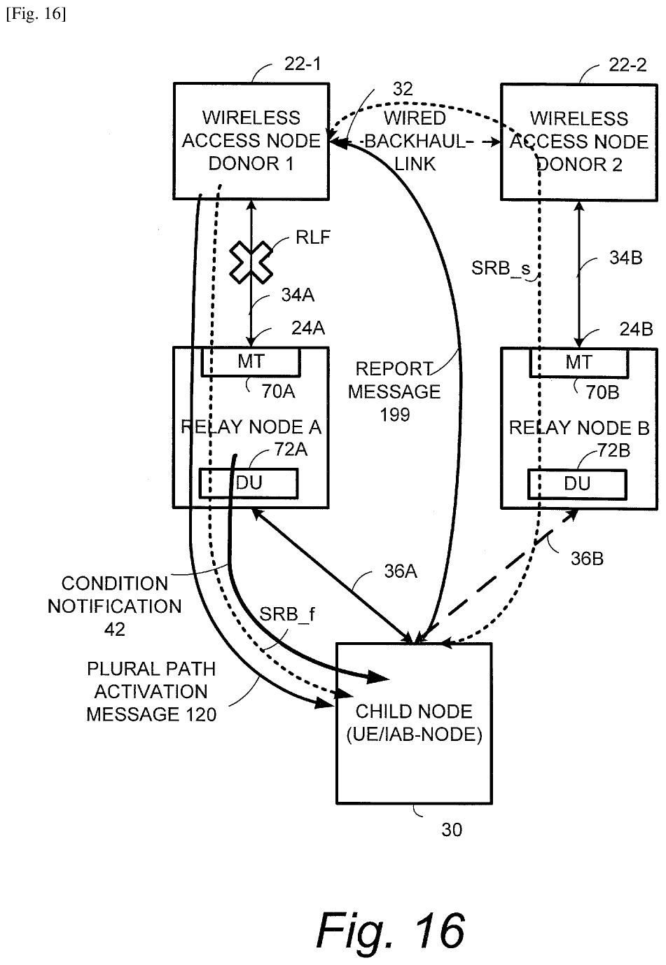

FIG. 16 shows yet another example diagram of a telecommunications system 20 which, like the telecommunications system 20 of FIG. 15, comprises wireless access node 22-1, also known as Donor node 1; wireless access node 22-2, also known as Donor node 2; IAB-node 24A, also known as Node A or relay node A; IAB-node 24B, also known as Node B or relay node B; and child node 1, also known as child node 30. The child node 30 may be, for example, a user equipment, UE, or Integrated Access and Backhaul (IAB) node, as previously described. The wireless access node 22-1 and wireless access node 22-2 may be connected by a wired backhaul link 32. The other elements of FIG. 16 may be connected by wireless backhaul links, e.g., the wireless access node 22-1 may be connected by wireless backhaul link 34A to IAB-node 24A; the wireless access node 22-2 may be connected by wireless backhaul link 34B to IAB-node 24B; the IAB-node 24A may be connected by wireless backhaul link 36A to child node 30; and the IAB-node 24B may be connected by 36B to child node 30.

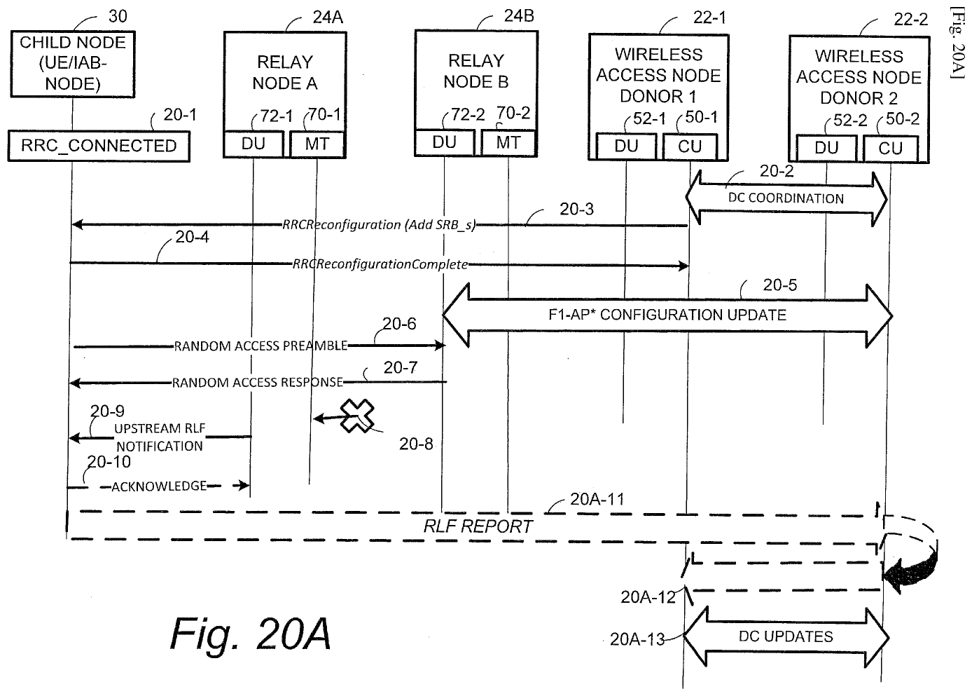

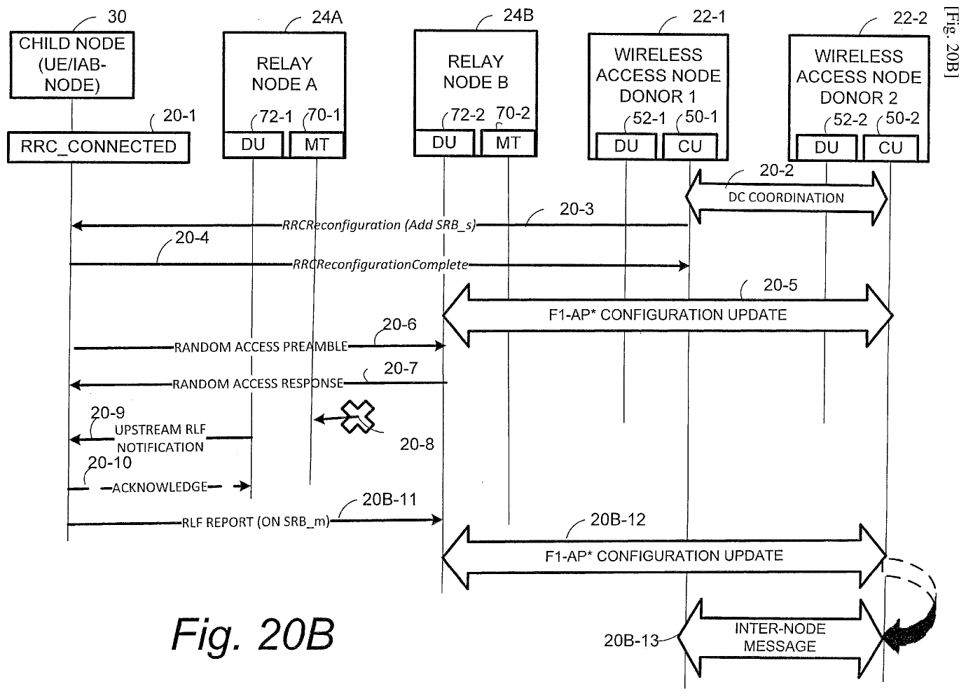

The example embodiments and modes of FIG. 16-FIG. 20A, FIG. 20B concern addressing problematic conditions on a wireless backhaul link using redundant links. In general terms, the wireless access node 22-1 generates and sends to child node 30 at message which comprises information configured to activate plural signaling data path, such as first signaling data path SRB_f and second signaling data path SRB_s shown in FIG. 16. The first signaling data path SRB_f is established between wireless access node 22-1 and the wireless terminal also known as child node 30, and has its signaling data routed via wireless access node 22-1 and IAB-node 24A. In one configuration, the second signaling data path SRB_s may be established between wireless access node 22-2 and child node 30 and has its signaling data relayed by IAB-node 24B. In another configuration (not shown in FIG. 16), the second signaling data path SRB_s may be established directly established between wireless access node 22-2 and child node 30 without being relayed by an IAB-node. It should be noted that either of the first or second signaling data path may be a master signaling radio bearer, e.g., the signaling data bearer that is established first, and the other signaling data path may be a secondary signaling radio bearer that may be added after the master signaling radio bearer is established.

Although the message(s) configured to activate the plural signaling data paths may be of any appropriate type and bear any suitable name, in an example embodiment and mode described herein the message is a reconfiguration message and, for sake of illustration, is arbitrarily and not exclusively known, and shown in FIG. 16, as the plural path activation message 140. The plural path activation message 140 is received by the child node 30, after which both the first signaling data path SRB_f and the second signaling data path SRB_s are activated. Should the child node 30 thereafter receive a notification from the IAB-node 24A, the child node 30 may generate a report message (also referred as a failure information message) and transmit the message through the second signaling path SRB_s. The report message may include information based on the notification, and the notification may be based on a radio condition detected on the first signaling data path.

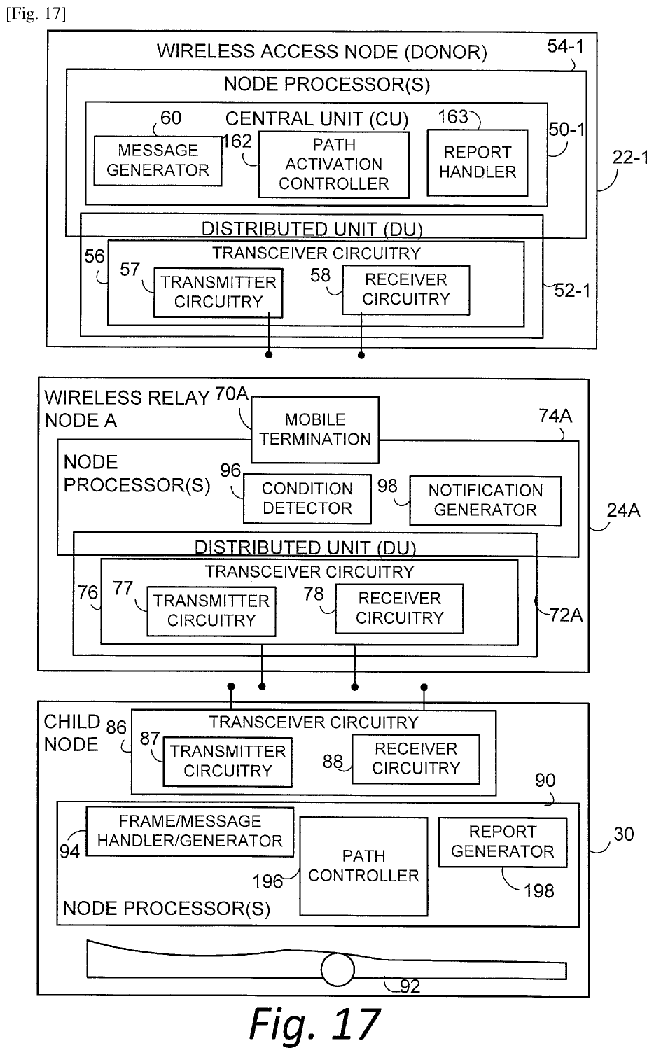

Various components and functionalities of the nodes shown in FIG. 16 are further shown in FIG. 17. Components of FIG. 17 which have similar names to the components of FIG. 12 also have comparable function. FIG. 17 shows wireless access node 22-1 as comprising central unit 50-1 and distributed unit 52-1. The central unit 50-1 and distributed unit 52-1 may be realized by, e.g., by comprised of or include one or more processor circuits, e.g., node processor(s) 54-1. The one or more node processor(s) 54-1 may be shared by central unit 50-1 and distributed unit 52-1 or each of central unit 50-1 and distributed unit 52-1 may comprise one or more node processor(s) 54-1. Moreover, central unit 50-1 and distributed unit 52-1 maybe co-located at a same node site, or alternatively one or more distributed units 52-2 may be located at sites remote from central unit 50-1 and connected thereto by a packet network. The distributed unit 52-1 may comprise transceiver circuitry 56, which in turn may comprise transmitter circuitry 57 and receiver circuitry 58. The transceiver circuitry 56 includes antenna(e) for the wireless transmission. Transmitter circuitry 57 includes, e.g., amplifier(s), modulation circuitry and other conventional transmission equipment. Receiver circuitry 58 comprises, e.g., amplifiers, demodulation circuitry, and other conventional receiver equipment.

As further shown in FIG. 17, node processor(s) 54-1 of wireless access node 22-1 may comprise message generator 60; plural path controller 162; and report handler 163. The message generator 60 serves to generate, e.g., plural path activation message 140 as described herein. The plural path controller 162 serves, e.g., to activate the plural paths, including first signaling data path SRB_f and second signaling data path SRB_s. The report handler 163 is configured to receive and process a report from child node 30 which is based on a notification representing a radio condition detected on one of the signaling data paths.

As shown in FIG. 17 the IAB-node 24A, also known as wireless relay node 24A, in an example embodiment and mode comprises relay mobile termination unit 70A and relay distributed unit 72A. The relay mobile termination unit 70A and relay distributed unit 72A may be realized by, e.g., by comprised of or include one or more processor circuits, e.g., relay node processor(s) 74A. The one or more relay node processor(s) 74A may be shared by relay mobile termination unit 70A and relay distributed unit 72A, or each of mobile termination unit 70A and distributed unit 72A may comprise one or more relay node processor(s) 74A. The relay node distributed unit 72A may comprise transceiver circuitry 76, which in turn may comprise transmitter circuitry 77 and receiver circuitry 78. The transceiver circuitry 76 includes antenna(e) for the wireless transmission. Transmitter circuitry 77 may include, e.g., amplifier(s), modulation circuitry and other conventional transmission equipment. Receiver circuitry 78 may comprise, e.g., amplifiers, demodulation circuitry, and other conventional receiver equipment.

FIG. 17 further shows that IAB-node 24A may comprise radio condition detector 80 and notification generator 82. Both condition detector 80 and notification generator 82 may be realized or comprised by relay node processor(s) 74. The notification generator 82 serves to generate the condition notification 42, based on a condition detected by condition detector 80.

It should be understood that, although not illustrated in FIG. 17, the wireless access node 22-2 and IAB-node 24B of FIG. 16 and of FIG. 17 may have similar components and functionalities as the wireless access node 22-1 and IAB-node 24A, respectively, but with differently numbered/alphabetized suffixes denoting comparable components.

FIG. 17 shows child node 30 as comprising, in an example, non-limiting embodiment and mode, transceiver circuitry 86. The transceiver circuitry 86 in turn may comprise transmitter circuitry 87 and receiver circuitry 88. The transceiver circuitry 76 includes antenna(e) for the wireless transmission. Transmitter circuitry 77 may include, e.g., amplifier(s), modulation circuitry and other conventional transmission equipment. Receiver circuitry 78 may comprise, e.g., amplifiers, demodulation circuitry, and other conventional receiver equipment. FIG. 17 further shows child node 30, which (as indicated before) may be a user equipment or Integrated Access and Backhaul (IAB) node, as also comprising node processor circuitry, e.g., one or more node processor(s) 90, and interfaces 92, including one or more user interfaces. Such user interfaces may serve for both user input and output operations, and may comprise (for example) a screen such as a touch screen that can both display information to the user and receive information entered by the user. The user interface 48 may also include other types of devices, such as a speaker, a microphone, or a haptic feedback device, for example.

In an example, non-limiting embodiment and mode shown in FIG. 17, the child node 30 may include frame/message generator/handler 94; path controller 196; and report generator 198. As is understood by those skilled in the art, in some telecommunications system messages, signals, and/or data are communicated over a radio or air interface using one or more “resources”, e.g., “radio resource(s)”. The frame/message generator/handler 94 serves to handle messages, signals, and data received from other nodes, including but not limited to incoming messages such as the plural path activation message 140 and condition notification 42 described herein, as well as outgoing messages such as a report message 199 generated by report generator 198. The path controller 196 works in conjunction with establishing, activating, and deactivating signaling data paths in which child node 30 participates, such as first signaling data path SRB_f and second signaling data path SRB_s.

In a most basic example embodiment and mode, a wireless access node of the technology disclosed herein transmits at least one message which activates a first signaling data path and a second signaling data path. The first signaling data path, e.g., first signaling data path SRB_f, and the second signaling data path, e.g., second signaling data path SRB_s, are both established between the wireless access node, e.g., wireless access node 22-1, and the wireless terminal, e.g., child node 30. Signaling data on the first signaling data path is relayed by a wireless relay node, e.g., IAB-node 24A. In a most basic example embodiment and mode of the technology disclosed herein, the wireless terminal, e.g., child node 30, receives such message. Further, the child node 30 may, as a condition on the first signaling data path SRB_f arises, processes a notification received from the wireless relay node and, upon reception of the notification, transmit a report message to the wireless access node on the second signaling data path. The report message comprises information based on the notification, and the notification is based on a radio condition detected on the first signaling data path.

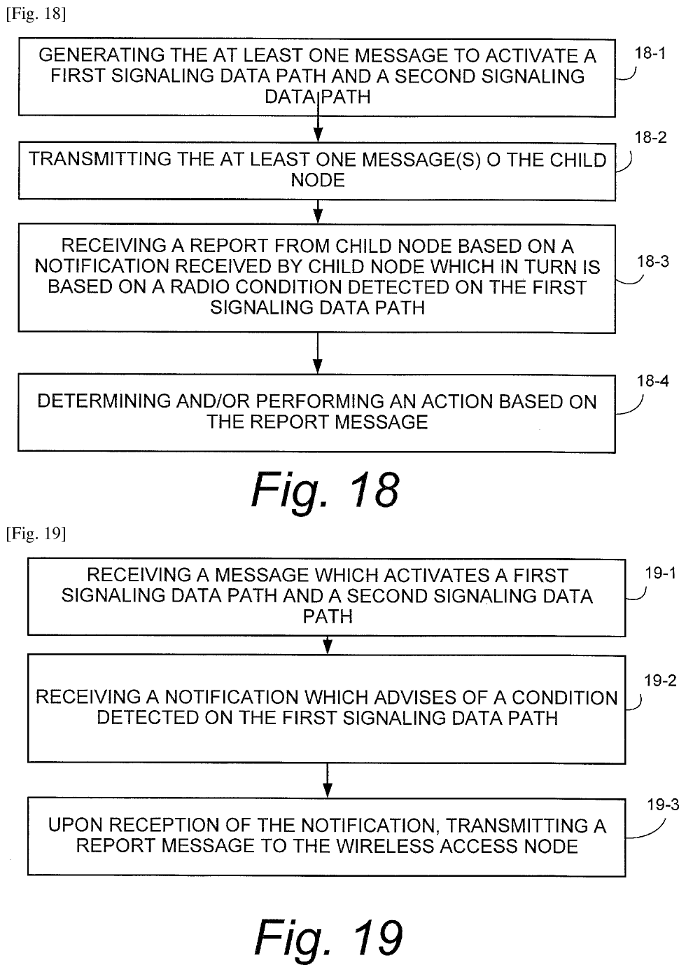

Beyond the basic example embodiment and mode mentioned above, FIG. 18 shows further example, non-limiting, basic acts or steps that may be performed by the wireless access node 22-1 of FIG. 16 and FIG. 17. Act 18-1 comprises generating the at least one message, e.g., the message(s) being configured to activate a first signaling data path and a second signaling data path. As mentioned above, the first signaling data path and the second signaling data path are established between the wireless access node and the wireless terminal, and the signaling data on the second signaling data path is relayed by a wireless relay node. The message(s) of act 18-1, which may be termed as the plural path activation message(s) 140, may be generated by message generator 60. Act 18-2 comprises transmitting the at least one message(s), e.g., the plural path activation message 140, to the child node 30. The plural path activation message 140 may be transmitted by the transmitter circuitry 57 of wireless access node 22-1.

A problematic condition may thereafter arise, and for sake of example is illustrated herein as a radio link failure occurring on first signaling data path SRB_f. Act 18-3 comprises the wireless access node 22-1 receiving a report from child node 30, and in particular receiving a report message comprising information based on a notification received by child node 30. The notification is preferably based on a radio condition detected on the first signaling data path. Such notification may be the condition notification 42 described herein. The report message, e.g., report message 199, may be received by receiver circuitry 58 and handled by report handler 163. Act 18-4 comprises determining and/or performing an action based on the report message. An example of such an action for act 18-4 may be, for example, deactivating the first signaling data path SRB_f.

Beyond the basic example embodiment and mode mentioned above, FIG. 19 shows further example, non-limiting, basic acts or steps that may be performed by child node 30 of FIG. 16 and FIG. 17. Act 19-1 comprises receiving a message which activates a first signaling data path and a second signaling data path, e.g., the first signaling data path SRB_f and the second signaling data path SRB_s. Act 19-2 comprises receiving a notification of a condition detected on the first signaling data path SRB_f. The message of act 19-1 may be the plural path activation message 140 described herein, generated by wireless access node 22-1; the message of act 19-2 may be the condition notification 42 described herein, generated by IAB-node 24A. The messages of both act 19-1 and act 19-2 may be received through receiver circuitry 88 and processed by frame/message generator/handler 94. Act 19-3 comprises, upon reception of the notification of act 19-2, transmitting a report message to the wireless access node. The report message comprises information based on the notification; the notification is based on a radio condition detected on the first signaling data path.

In an example scenario shown in FIG. 16, child node 30, e.g., Child Node 1, which may be an IAB-node or a UE, establishes redundant connections (i.e. multiple connections or simultaneous connections, such as Dual Connectivity (DC)) for at least the signaling radio bearer (SRB) (and possibly the data radio bearers (DRBs) as well). In the scenario of FIG. 16, the SRB may be carried by two (or more) separate paths: (1) signaling data path SRB_f which includes wireless access node 22-1, IAB-node 24A, and child node 30, e.g., Donor 1-Node A-Child Node 1(SRB_f) and (2) signaling data path SRB_s which involves wireless access node 22-1, wireless access node 22-2, IAB-node 24B, and 30, e.g., Donor1-Donor2-Node B-Child Node 1(SRB_s). In one configuration, the wireless access node 22-1, e.g., Donor 1, may act as a master node while wireless access node 22-2, e.g., Donor 2, may behave as a secondary (or slave) node. In another configuration, the wireless access node 22-1, e.g., Donor 1, may act as a secondary (or slave) node while wireless access node 22-2, e.g., Donor 2, may behave as a master node. In one configuration, signaling data may duplicated and transmitted on the multiple paths, e.g., on first signaling data path SRB_f and second signaling data path SRB_s. In another configuration, packets for signaling data are split into the two paths, e.g., first signaling data path SRB_f and second signaling data path SRB_s, for increased throughput.

After establishing an RRC connection to wireless access node 22-1, e.g., to Donor 1, the Child Node 30 may be provisioned with a configuration with a secondary cell served by the wireless access node 22-2 and IAB-node 24B. Following the configuration, the Child Node 30 may use the multiple paths for transmitting/receiving signaling bearer (and possibly data bearers). In the present example embodiment and mode, at least one of the parent nodes of the Child node 30 may send some of the aforementioned notifications representing the radio condition of its upstream radio link. That is, either IAB-node 24A or IAB-node 24B may send such notifications as and when the radio condition(s) occur. For example, similar to the previously disclosed embodiments, when detecting a radio link failure (RLF) on the upstream radio link of IAB-node 24A, the IAB-node 24A may send the Upstream RLF notification to its child nodes including the Child Node 30. In this case, the Child Node 30 may attempt to report this event to at least one of the serving donors using a path not affected by the RLF. In the scenario shown in the FIG. 16, the Child Node 30 may use the path SRB_s to send the report to the wireless access node 22-2 through the IAB-node 24B. In some example configurations, the report may be also conveyed to the wireless access node 22-1, e.g., to Donor 1, which may decide to reconfigure updated redundant connections to the Child Node 30.

FIG. 20A shows an example message flow for the scenario shown in FIG. 16, where the Child Node 30 may first establish an RRC connection with the Donor 1, which results in setting up the SRB_f. While the Child node 30 is in RRC_CONNECTED (depicted as act 20-1 in FIG. 20A), the wireless access node 22-1 may decide to configure an additional connection and, as represented by act 20-2, start a coordination with wireless access node 22-2. It should be noted that, similar to the previously disclosed embodiment, the wireless access node 22-1 and the wireless access node 22-2 may be physically collocated or separated entities, or even the same entity. As act 10-3 wireless access node 22-1 may send to the Child Node 30 RRCReconfiguration comprising a configuration to add a new SRB (SRB_s) and an identity of the cell to serve SRB_s, the identity of the cell served by IAB-node 24B. As act 20-4 Child Node 30 may then acknowledge to RRCReconfiguration by sending a RRCReconfigurationComplete message. As act 20-5 wireless access node 22-2 may use F1-AP* to update the routing configurations at the Node B, e.g., at IAB-node 24B, for the Child Node 30.

As act 20-6 the child node 30 may initiate a random access procedure by sending a Random Access Preamble message, and as act 20-7 may receive a Random Access Response message. The random access procedure of act 20-6 and act 207 serves to synchronize child node 30 to the IAB-node 24B.

Eventually, as act 20-8, IAB-node 24A may detect a specified radio condition on its upstream link. In the example scenario shown in FIG. 20A, the specified upstream condition may be a radio link failure (RLF), but could be other radio link condition(s) as well. Act 20-9 comprises IAB-node 24A sending a notification, e.g., condition notification 42, to child node 30. In the example scenario shown in FIG. 20A, in which the specified upstream condition may be a radio link failure (RLF), the condition notification 42 may be an Upstream RLF notification which may be sent to child nodes/UEs of IAB-node 24A, including but not necessarily limited to Child Node 30. As act 20-10 Child Node 30 may send back an acknowledgement of the condition notification 42 to IAB-node 24A. Further, upon receipt of the notification of act 20-9, e.g., upon receipt of condition notification 42, as act 20-11 the child node 30 may generate and transmit a report message reporting the RLF occurring on the path for SRB_f. The report message 199 may be generated by report generator 198 upon receipt of the condition notification 42.

In one example embodiment and mode shown in FIG. 20A, the report message of act 20-11 is an RRC message of act 20-11 directed to the Donor 1, e.g., to wireless access node 22-1. As Act 20A-12, the Donor 2, e.g., wireless access node 22-2, may transfer the report message to the Donor 1 using an inter-node message on the wired backhaul link 32. Upon receipt of the report message, the Donor 1 may coordinate with the Donor 2 to deactivate the problematic signaling data path (e.g. the first signaling data path SRB_f), as shown in Act 20A-13. In one implementation, the wireless access node 22-1 aka Donor 1, now recognizing that SRB_f is torn down, may reconfigure the Child Node 30 with a new SRB configuration, e.g. releasing SRB_f. by sending another RRCReconfiguration. In parallel, wireless access node 22-1 may also use the F1-AP* to update the routing configuration of the Child Node 30, if the Child Node 30 is an IAB-node.

In another example embodiment and mode shown in FIG. 20B, the report message 42 of act 20B-11 is addressed to the parent node, e.g., IAB-node 24B using the Adaptation Layer, the RLC Layer, the MAC Layer or the physical layer signaling. Then, as act 20B-12, the parent node IAB-node 24B may convey the report message using a protocol, e.g., F1-AP*, to the Donor 2, e.g., to wireless access node 22-2. As act 20B-13 the wireless access node 22-2 may redirect the report message to the Donor 1, e.g., wireless access node 22-1, using an inter-node message on the wired backhaul link 32. Similar to the previous embodiment and mode shown in FIG. 20A, in one implementation, the wireless access node 22-1 aka Donor 1, now recognizing that SRB_f is torn down, may reconfigure the Child Node 30 with a new SRB configuration, e.g. releasing SRB_f. by sending another RRCReconfiguration. In parallel, wireless access node 22-1 may also use the F1-AP* to update the routing configuration of the Child Node 30, if the Child Node 30 is an IAB-node.

In either the example embodiment and mode of FIG. 20A or the example embodiment and mode of FIG. 20B, upon receipt of the report message 199 the wireless access node 22-1 may take appropriate action, such as for example, deactivating the first signaling data path SRB_f.

In one example embodiment and mode, the Child Node is preconfigured to send the report message upon receiving one of designated notifications from the parent node, e.g., from IAB-node 24A. In another example embodiment and mode, the Child Node is configured by an IAB-donor node to send the report message upon receiving one of designated notifications. In this latter case, RRCReconfiguration may be used to configure the designated notifications for sending report message.

Accordingly, in the example embodiment and mode of FIG. 16-FIG. 20A and FIG. 20B, an IAB-node or a UE configured with multiple radio paths for the signaling radio bearer(s) may receive from one parent node a notification representing the radio condition of the upstream radio link of one of the parent nodes. The IAB-node or the UE may use one or more other radio paths to send a report message reporting the radio condition to at least one IAB-donor node. The IAB-donor node that receives the report message may initiate reconfiguration for updated topology and/or routing of the relay network accordingly.

Preventing Routing Loops in Cell Selection

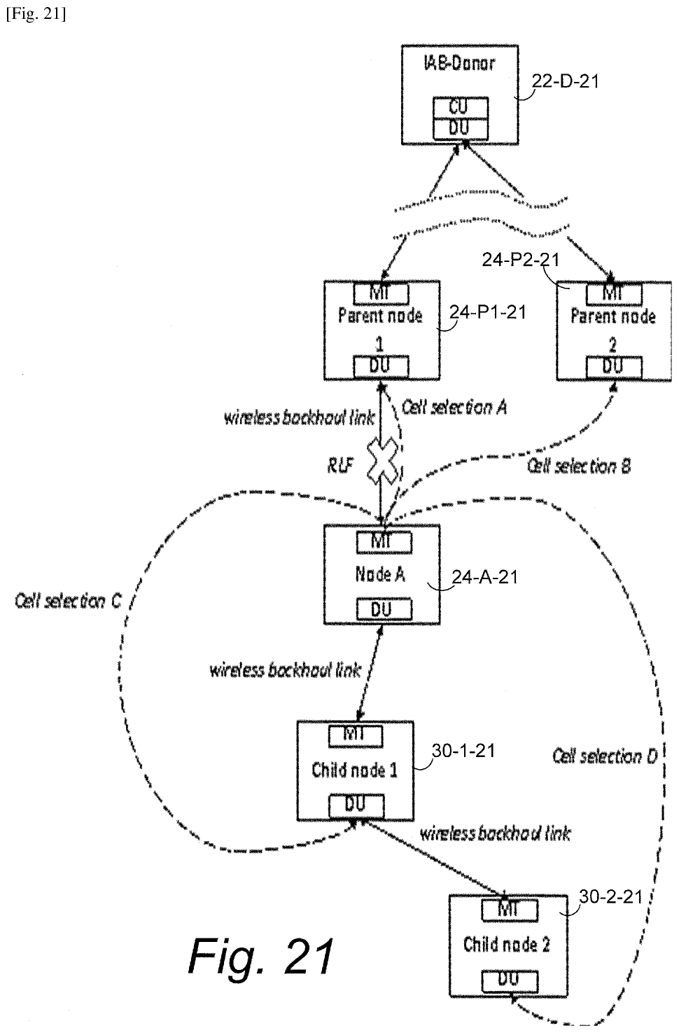

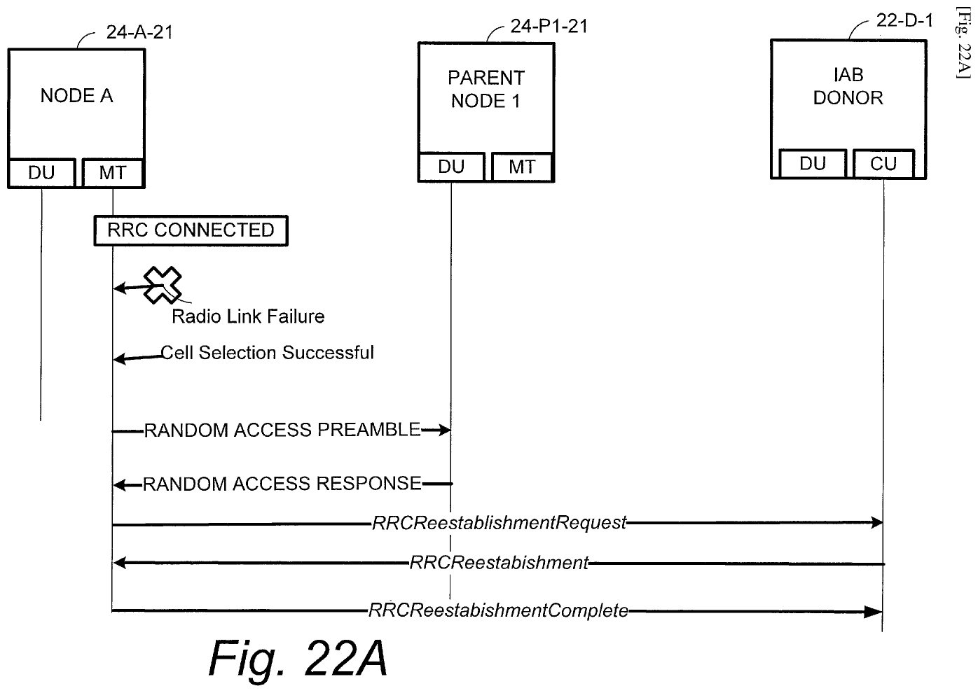

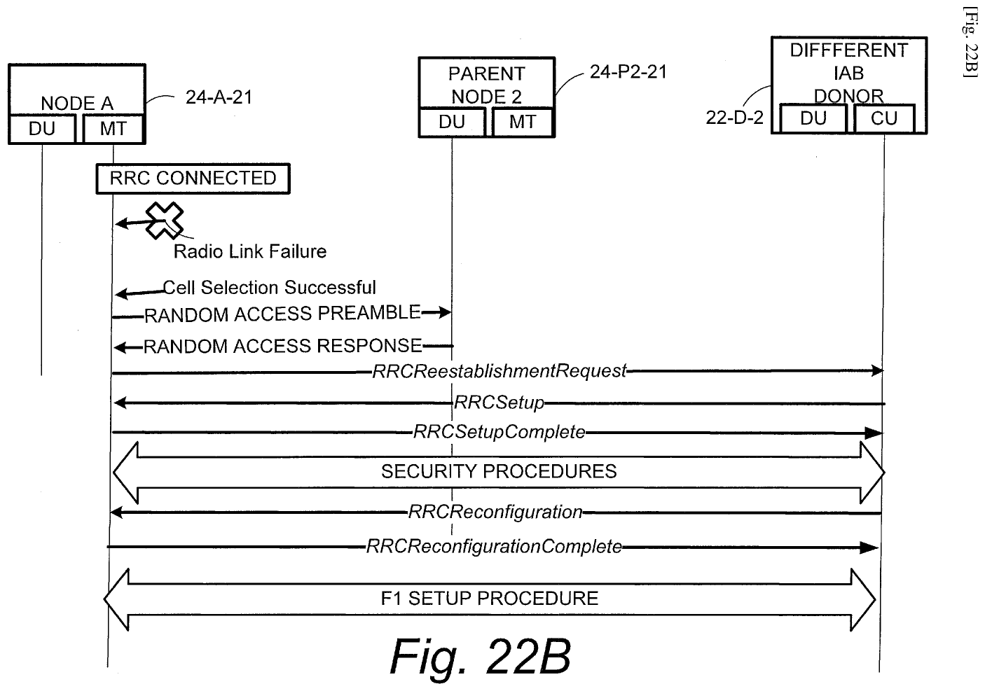

As disclosed in the aforementioned embodiments and modes, the MT part of an IAB-node may perform a cell selection procedure upon detecting a Radio Link Failure, RLF, on its upstream radio link. FIG. 21 illustrates an example scenario, where Node 24-A-21, an IAB-node, detects an RLF on the backhaul radio link to the current parent node (Parent node 22-P1_21). Eventually Node 24-A-21 may start to perform the cell selection procedure, attempting to find a suitable cell with sufficient signal quality. As a result of the cell selection, the MT part of Node 24-A-21 may be able to find the original parent node (Parent node 24-P1-21) that served before the RLF (Cell Selection A in FIG. 21). In this case, Node 24-A-21 may initiate the RRC reestablishment procedure shown in FIG. 22A by sending RRCReestablishmentRequest to the IAB-donor 22-D-21 via Parent node 22_P1-21, in order to recover the broken upstream link. Upon receiving the RRCReestablishmentRequest, the IAB-donor 22-D-21 may retrieve the connection context (e.g. security keys, etc.) for the MT part of Node 24-A-21, and then may respond to Node 24-A-21 with RRCReestablishment, Node 24-A-21 may complete the RRC reestablishment procedure by sending RRCReestablishmentComplete.

If Node 24-A-21 fails to find the original parent and selects another parent node (e.g. Cell selection B to Parent node 24-P2-21 in FIG. 21), the MT part of Node 24-A-21 may initiate the RRC reestablishment procedure, similar to the cell selection case of FIG. 22A. In this case, if Parent node 24-P2-21 is connected to the same IAB-donor 22-D-21, or if Parent node 24-P2-21 is connected to a different IAB-donor (not illustrated) and the different IAB-donor is able to retrieve the connection context for the MT part of Node 24-A-21, the RRC establishment procedure may be successfully performed in a way similar to the flow shown in FIG. 22A. If the different IAB-donor fails to retrieve the connection context, the different IAB-donor and Node 24-A-21 may follow the message flow shown in FIG. 22B where the IAB-donor may respond back to Node 24-A-21 with RRCSetup, to setup a brand-new RRC connection, and in turn, Node 24-A-21 may send RRCSetupComplete, followed by the security procedure, similar to the flow shown in FIG. 6B.

It should be noted that, upon detecting the RLF, Node 24-A-21 may or may not immediately transmit the aforementioned upstream RLF notification to its child nodes (e.g. Child node 30-1-21 in FIG. 21). Transmission of the upstream RLF notification may be determined based on the previously disclosed embodiments.

FIG. 21 also serves to illustrate a potential problematic situation wherein, during the cell selection procedure, Node 24-A-21 ends up with discovering downlink broadcast transmission (synchronization signals, system information, etc.) from the DU parts of its child nodes (e.g., Child node 30-1-21, as shown by the arrow labeled “Cell selection C”) or from the DU parts of its grandchild nodes (Child node 30-2-21, as shown by the arrow labeled “Cell selection D”). In such a situation, without proper configurations, Node 24-A-21 may not be able to recognize that the downlink broadcast transmission is indeed from a (grand)child IAB-node in its own downstream path. As a result, if the signal quality is sufficient, Node 24-A-21 may choose to camp on the (grand)child node, and eventually any signaling (e.g. RRC, F1AP, etc.) addressed to the IAB-donor would be circulated in a closed loop. A closed loop in a relay network may be referred as a “routing loop”, and the network topology that forms a routing loop may be referred as loop topology.

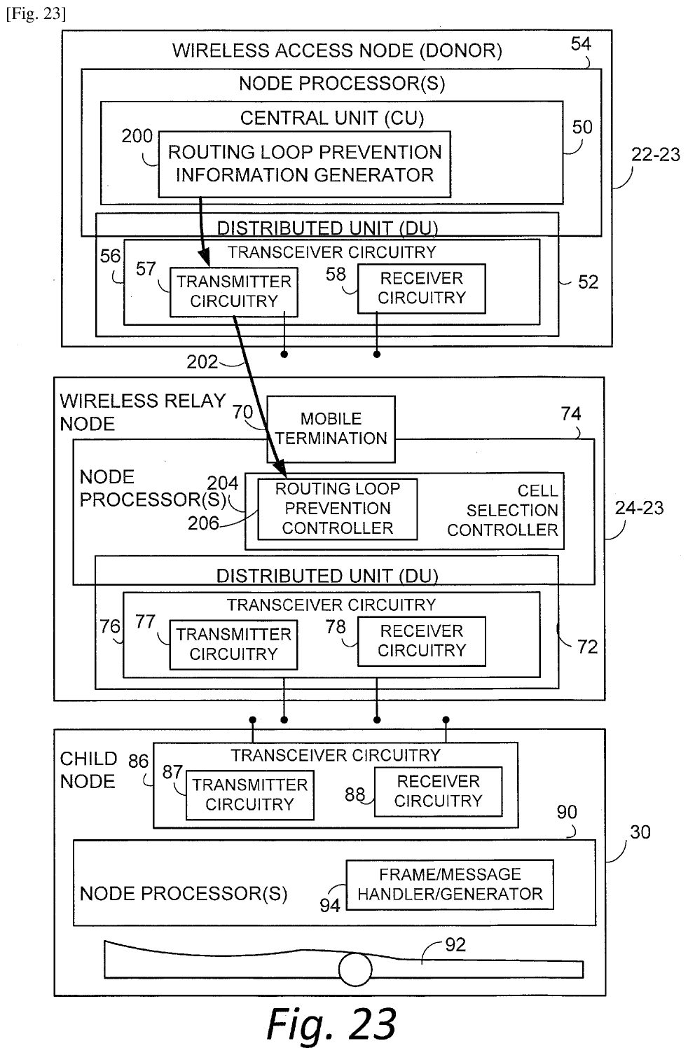

Various embodiments and modes described herein are configured to address and/or combat the routing loop problem. FIG. 23 shows a telecommunication system 20-23 which generically addresses a potential routing loop situation using routing loop prevention information that may be utilized by an Integrated Access and Backhaul (IAB) node in order to prevent the node from selecting a cell of one of its children or grandchildren nodes. Components of FIG. 23 which have similar names to the components of FIG. 12 and/or FIG. 17 also have comparable function, unless otherwise noted or clear from the context.

FIG. 23 shows wireless access node 22-23, also known as IAB-donor node 22-23, as comprising central unit 50 and distributed unit 52. The central unit 50 and distributed unit 52 may be realized by, e.g., by comprised of or include one or more processor circuits, e.g., node processor(s) 54-1. The one or more node processor(s) 54-1 may be shared by central unit 50 and distributed unit 52 or each of central unit 50 and distributed unit 52 may comprise one or more node processor(s) 54. Moreover, central unit 50 and distributed unit 52 maybe co-located at a same node site, or alternatively one or more distributed units 52 may be located at sites remote from central unit 50 and connected thereto by a packet network. The distributed unit 52 may comprise transceiver circuitry 56, which in turn may comprise transmitter circuitry 57 and receiver circuitry 58. The transceiver circuitry 56 includes antenna(e) for the wireless transmission. Transmitter circuitry 57 includes, e.g., amplifier(s), modulation circuitry and other conventional transmission equipment. Receiver circuitry 58 comprises, e.g., amplifiers, demodulation circuitry, and other conventional receiver equipment.

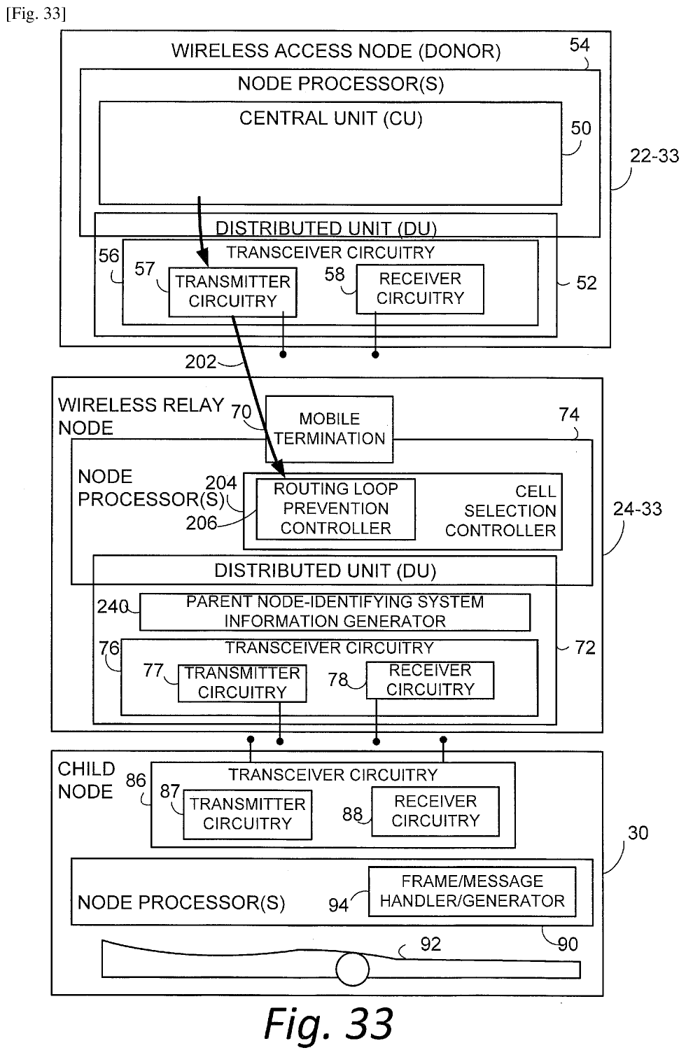

As further shown in FIG. 23, node processor(s) 54 of wireless access node 22-23 may comprise routing loop prevention information generator 200. The routing loop prevention information generator 200 generates routing loop prevention information that, when received by an Integrated Access and Backhaul (IAB) node, may be used by the Integrated Access and Backhaul (IAB) node to avoid selecting any of its children or grandchildren nodes in a cell selection procedure. Differing types of routing loop prevention information are described herein in differing embodiments and modes. For example, in the example embodiment and mode of FIG. 23C the routing loop prevention information is configuration information, whereas in the example embodiment and mode of FIG. 33-FIG. 37 the routing loop prevention information is carried by system information. FIG. 23 further shows that the transmitter circuitry 57 of wireless access node 22-23 may transit a signal or message 202 comprising the routing loop prevention information, e.g., routing loop prevention information message 202, over a radio interface to other Integrated Access and Backhaul (IAB) nodes.

As shown in FIG. 23 the IAB-node 24-23, also known as wireless relay node 24-23, in an example embodiment and mode comprises relay mobile termination unit 70 and relay distributed unit 72. The relay mobile termination unit 70 and relay distributed unit 72 may be realized by, e.g., by comprised of or include one or more processor circuits, e.g., relay node processor(s) 74. The one or more relay node processor(s) 74 may be shared by relay mobile termination unit 70 and relay distributed unit 72, or each of mobile termination unit 70 and distributed unit 72 may comprise one or more relay node processor(s) 74. The relay node distributed unit 72 may comprise transceiver circuitry 76, which in turn may comprise transmitter circuitry 77 and receiver circuitry 78. The transceiver circuitry 76 includes antenna(e) for the wireless transmission. Transmitter circuitry 77 may include, e.g., amplifier(s), modulation circuitry and other conventional transmission equipment. Receiver circuitry 78 may comprise, e.g., amplifiers, demodulation circuitry, and other conventional receiver equipment.

FIG. 23 further shows that IAB-node 24-23 may comprise cell selection procedure controller 204. The cell selection procedure controller 204 serves to initiate and perform a cell selection procedure when the JAB node 24-23 has detected or experienced, e.g., a radio link failure (RLF), and therefore needs to select another cell or, if the RLF is temporary, attempt to re-select the same cell if able to do so. In addition, the IAB node 24-23 comprises cell selection routing loop prevention controller 206. The cell selection routing loop prevention controller 206 may comprise or be included in cell selection procedure controller 204, which may in turn be realized or comprised by relay node processor(s) 74.

FIG. 23 shows child node 30 as comprising, in an example, non-limiting embodiment and mode, transceiver circuitry 86. The transceiver circuitry 86 in turn may comprise transmitter circuitry 87 and receiver circuitry 88. The transceiver circuitry 76 includes antenna(e) for the wireless transmission. Transmitter circuitry 77 may include, e.g., amplifier(s), modulation circuitry and other conventional transmission equipment. Receiver circuitry 78 may comprise, e.g., amplifiers, demodulation circuitry, and other conventional receiver equipment. FIG. 23 further shows child node 30, which (as indicated before) may be a user equipment or Integrated Access and Backhaul (IAB) node, as also comprising node processor circuitry, e.g., one or more node processor(s) 90, and interfaces 92, including one or more user interfaces. Such user interfaces may serve for both user input and output operations, and may comprise (for example) a screen such as a touch screen that can both display information to the user and receive information entered by the user. The user interface 48 may also include other types of devices, such as a speaker, a microphone, or a haptic feedback device, for example.

In an example, non-limiting embodiment and mode shown in FIG. 23, the child node 30 may include frame/message generator/handler 94. As is understood by those skilled in the art, in some telecommunications system messages, signals, and/or data are communicated over a radio or air interface using one or more “resources”, e.g., “radio resource(s)”. The frame/message generator/handler 94 serves to handle messages, signals, and data received from other nodes.

FIG. 24 shows example, representative acts or steps performed by the wireless access node 22-23 of FIG. 23. Act 24-1 comprises including routing loop prevention information for a cell selection procedure in a message. The routing loop prevention information may be generated, for example, by node processor(s) 54 and the routing loop prevention information generator 200 in particular. Alternatively, the routing loop prevention information may be generated by a network entity, such a network server that comprises either the radio access network or a core network. In the event that the routing loop prevention information is generated by a network server, the node processor(s) 54 may serve to include the server-generated routing loop prevention information into a routing loop prevention information message. Act 24-2 comprises transmitting the routing loop prevention information message to a wireless relay node, such as in routing loop prevention information message 202, for example.

FIG. 25 shows example, representative acts or steps performed by the IAB node 24-23 of FIG. 23. Act 25-1 comprises receiving routing loop prevention information, e.g., receiving routing loop prevention information message 202. Act 25-2 comprises using the routing loop prevention information in a cell selection procedure to select a cell as a candidate. The routing loop prevention information precludes the IAB node 24-23 from selecting a cell of one of its child or grandchild nodes.

Various example embodiments and modes generically covered by the example embodiment and mode of FIG. 23 are now further described. In the ensuing descriptions of the nodes of the telecommunications systems of the further example embodiments and modes, any suffixes affixed to node descriptors are done so for sake of simplicity of reference, it being understood that such nodes are still subsumed under the general and generic embodiment and mode and that comments directed to such suffixed node appellations are not necessarily and generally are not confined to that particular example embodiment and mode. Moreover, it should be understood that features and/or components of the various example embodiments and modes and implementations described herein may be combined with one another.

Preventing Routing Loops in Cell Selection: Using Configuration Parameter(s)

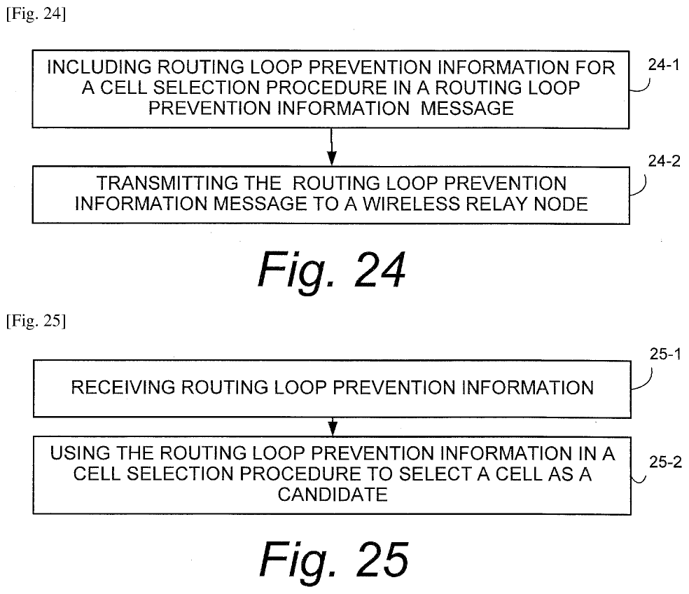

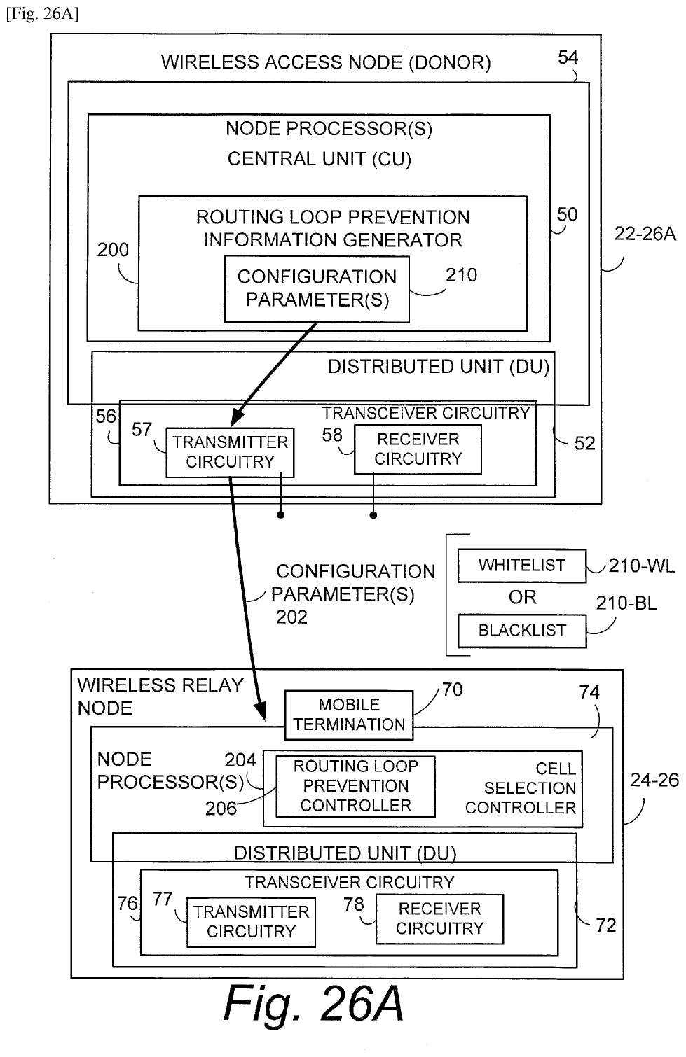

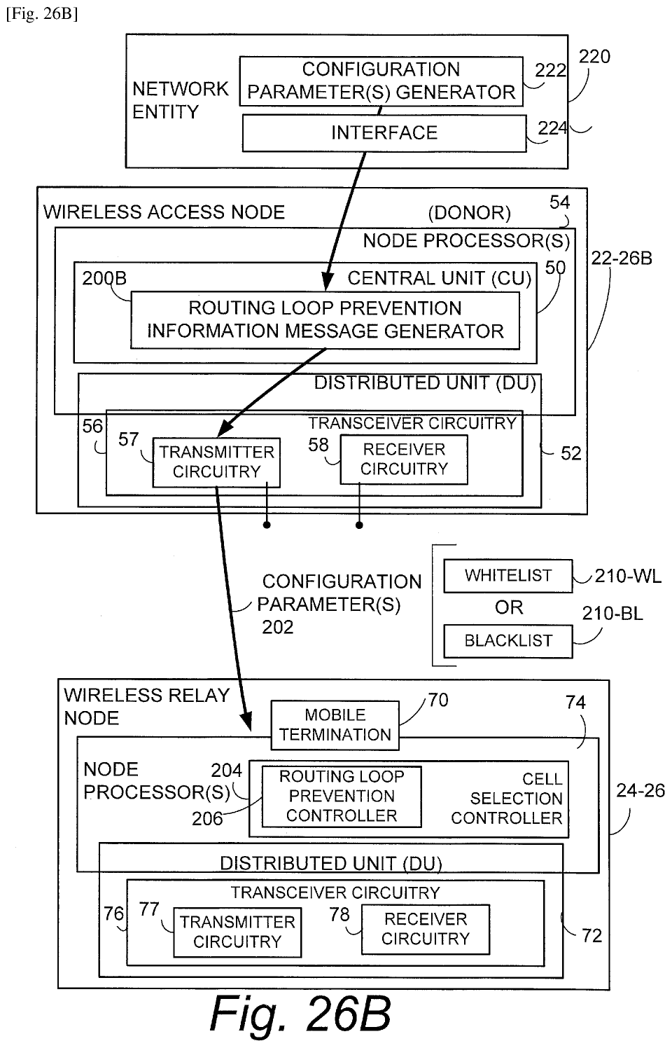

In order to prevent a routing loop from happening, in some example embodiments and modes illustrated in FIG. 26A and FIG. 26B, the routing loop prevention information may be configuration information. Accordingly, an IAB-node 24-26 (e.g., a node such as 24-A-21 of FIG. 21 or IAB node 24-23 of FIG. 23) may be configured with configuration parameters 210 to provide guidelines (or policies, rules, restrictions, etc.) to help the IAB-node 24-26 to perform cell selections after an event such as an RLF.

In the example implementation of FIG. 26A the configuration parameters may be generated by routing loop prevention information generator 200 of wireless access node 22-26A, and may be included in the routing loop prevention information message 202 provided to an IAB-node 24-26 while the IAB-node is connected with IAB-donor 22-26A (e.g., before an RLF). In one example configuration or implementation shown in FIG. 26A, the configuration parameters 210 may be generated by the CU part of the IAB-donor 22-26 and transmitted by its DU part via (broadcast or dedicated) signaling, such as RRC and F1AP.

In another example implementation shown in FIG. 26B the configuration parameters 210 may be generated and transmitted by a network entity, such as a network server 220. In an example embodiment and mode, the network entity 220 may comprise server configuration parameter(s) generator 222, which may comprise or be realized by processor circuitry, and network server interface 224. The server processor circuitry or server configuration parameter(s) generator 222 is configured to generate routing loop prevention information for a cell selection procedure in a message. The interface 224 is configured to transmit the routing loop prevention information message through a radio access network to a wireless relay node. The routing loop prevention information may be generated by a configuration parameter generator 222 of the network server 220 and transmitted to wireless access node 22-26B via IP data packets. The wireless access node 22-26B may then include the routing loop prevention information which was generated by network server 220 in the routing loop prevention information message 202. In the example embodiment and mode of FIG. 26B, the CU of wireless access node 22-26B may thus serve as a routing loop prevention information message generator 200B. The configuration parameters that were generated by the server configuration parameter(s) generator 222 of network entity 220 may thus be included in a routing loop prevention information message by message generator 200B, which may comprise the CU part of the IAB-donor 22-26B, and be transmitted by the DU part of wireless access node 22-26B via (broadcast or dedicated) signaling, such as RRC and F1AP. The IAB-node 24-26 that receives the configuration parameters may save them in its storage and may make use of them upon an event such as an RLF.

In one configuration or implementation of the example embodiments and modes such as FIG. 26A and FIG. 26B, for example, the configuration parameters may comprise a “whitelist” of cell/node identities, which white-listed cell/node identities the IAB-node 24-26 may be allowed to select during the cell selection procedure. The cell/node identities may be Physical Cell IDs (PCIs), NR Cell Identities (CellIdentities or NCIs), NR Cell Global Identifiers (NCGIs), gNB identifiers (gNB IDs), Global gNB identifiers (all specified in 3GPP TS 38.300, all existing versions thereof being incorporated herein by reference), or any other identifiers to identify cells/nodes. During RRC_CONNECTED state, the IAB-donor such as wireless access node 22-26A of FIG. 26A or a network entity such as network entity 220 of FIG. 26B may generate a whitelist 210-WL for the IAB-node, which may include identities of cells/nodes near by the IAB-node and may exclude the identities of cells served by the DU parts of the IAB-node's (grand)child nodes. The whitelist 210-WL may be updated and sent to the IAB-node as necessary. For example, when an IAB-node nearby IAB node 24-26 (the nearby Integrated Access and Backhaul (IAB) node not being illustrated) becomes a (grand)child node of IAB node 24-26, the cell/node identity of the nearby IAB-node may be removed from the whitelist (if already included) and the updated whitelist may be sent to IAB node 24-26. Likewise, when a (grand)child node of IAB node 24-26 hands over to another IAB-node and no longer is a (grand)child node of IAB node 24-26, cell/node identity for such an IAB-node may now be added to the whitelist to be sent to JAB node 24-26. In one configuration, upon an update the entire whitelist 210-WL may be delivered to IAB node 24-26. Additionally or alternatively, only updated parts of the whitelist may be delivered (such as a “to add”, “to modify” or “to remove” list).

In a case that the whitelist 210-WL comprises a list of PCIs (or one or more ranges of PCIs), upon an RLF the MT part of IAB node 24-26 may initiate the cell selection procedure, where the MT part attempts to acquire synchronization signals, such as Primary Synchronization Signal (PSS) and Secondary Synchronization Signal (SSS), from neighbor cells. If the PCI decoded from the synchronization signals broadcasted by one of the neighbor cells is included in the whitelist 210-WL, the MT part may proceed to further acquiring system information blocks (such as MIB and SIB1) from the cell. Otherwise, the MT part of Node A may consider the cell as not a candidate (“not suitable” or “barred”) and continue the cell selection process by searching for other cells. Meanwhile, in a case that the whitelist comprises a list of CellIdentity fields, the MT part of Node A may acquire the synchronization signals, MIB and SIB1, and if a CellIdentity(s) contained in SIB1 is included in the whitelist, the cell selection may be successfully completed. If the CellIdentity(s) is not in the whitelist, the MT part of Node A may continue the cell selection process, searching for other cells.

In an example, non-limiting implementation, the whitelist 210-WL may be a prioritized list. In such prioritized case, if IAB node 24-26 Node A finds a low-priority cell, it may continue to find higher priority cells in the whitelist 210-WL. In one configuration, cells served by IAB-nodes/IAB-donor may of higher priority than cells with no IAB capabilities.

In another configuration of the example embodiment and mode, the configuration parameters may comprise a “blacklist” 200-BL of cell/node identities, which the IAB-node 24-26 should avoid during cell selections. Similar to the previous configuration, the cell identities may be Physical Cell IDs (PCIs), NR Cell Identities (CellIdentitys or NCIs), NR Cell Global Identifiers (NCGIs), gNB identifiers (gNB IDs), Global gNB identifiers, or any other identifies to identify cells/nodes. During RRC_CONNECTED state, the IAB-donor such as wireless access node 22-26A of FIG. 26A or a network entity such as network entity 220 of FIG. 26B may generate a blacklist 200-BL for the IAB-node 24-26, which may include identities of cells served by (grand)child nodes of the IAB-node of concern. The blacklist 200-BL may further comprise identities of nearby cells served by nodes with no IAB capabilities. The blacklist may be updated and sent to the IAB-node 24-26 as necessary. For example, when another IAB-node (not illustrated) which is nearby IAB node 24-26 becomes a (grand)child node of IAB node 24-26, the cell/node identity of the nearby IAB-node may be added to the blacklist and the updated blacklist 200-BL may be sent to IAB node 24-26. Likewise, when a (grand)child node of TAB node 24-26 hands over to another TAB-node and no longer is a (grand)child node of IAB node 24-26, the cell/node identity of such an IAB-node may be removed from the blacklist and an updated blacklist may be sent to IAB node 24-26. Similar to the whitelist 200-WL, the entire blacklist 200-BL or only updated parts of the blacklist (such as a “to add”, “to modify” or “to remove” list) may be delivered.

In a case that the blacklist 200-BL comprises a list of PCIs (or one or more ranges of PCIs), upon an RLF the MT part of IAB node 24-26 may initiate the cell selection procedure, where the MT part attempts to acquire synchronization signals, such as Primary Synchronization Signal (PSS) and Secondary Synchronization Signal (SSS), from neighbor cells. If the PCI decoded from the synchronization signals broadcasted by one of the neighbor cells is not included in the blacklist 200-BL, the MT part may proceed to further acquiring system information blocks (such as SIB1) from the cell. Otherwise, the MT part of IAB node 24-26 may consider the cell as not a candidate (“not suitable” or “barred”) and continue the cell selection process by searching for other cells. Meanwhile, in a case that the blacklist comprises a list of CellIdentity fields, the MT part of IAB node 24-26 may acquire the synchronization signals, MIB and SIB1, and if a CellIdentity(s) contained in SIB1 is not included in the blacklist 200-BL, the cell selection may be successfully completed. If the CellIdentity(s) is in the blacklist 200-BL, the MT part of IAB node 24-26 may continue the cell selection process, searching for other cells.

In addition, the blacklist 200-BL may further include some topology information associated with cell/node identities. That is, the topology information may indicate parent-child relationship among entries of the blacklist 200-BL. For example, in the case of FIG. 21, after Child node 30-2-21 is attached to the relay network, the blacklist 200-BL may indicate Child node 30-2-21 as a direct child of Node 24-A-21 and Child node 30-2-21 as a direct child of Child node 30-1-21. A blacklist 200-BL with topology information may be referred as a routing table, or a topology table.

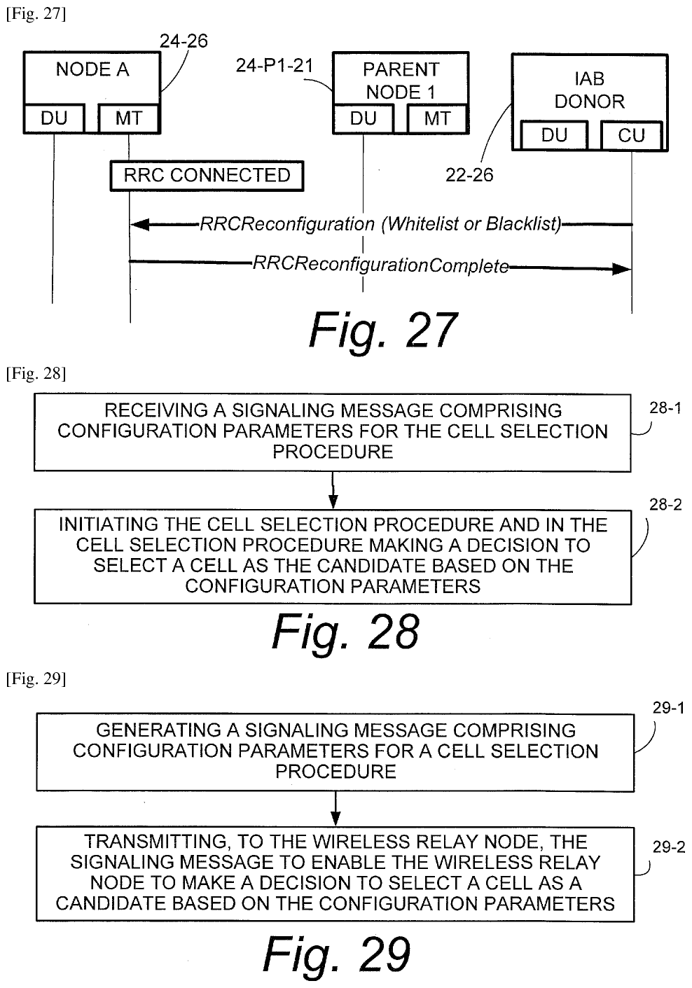

Either the whitelist 200-WL or the blacklist 200-BL may be carried via RRCReconfiguration message to the MT part of an IAB-node as shown in the example message flow of FIG. 27. Alternatively, either the whitelist 200L or the blacklist 200-BL may be carried via an F1-AP message to the DU part of an IAB-node, then handed to a MT part collocated in the IAB-node. The MT part of IAB node 24-26 may save the list, e.g., either whitelist 200-WL or blacklist 200-BL, and upon a radio link failure (RLF) the MT part of the IAB node 24-26 may use the latest list, either whitelist 200-WL or blacklist 200-BL, for cell selections.

FIG. 28 shows example, representative acts or steps which may be performed by the IAB node 24-26 of FIG. 26A and FIG. 26B. Act 28-1 comprises receiving a signaling message comprising configuration parameters for the cell selection procedure. Act 28-2 comprises initiating the cell selection procedure and in the cell selection procedure making a decision to select a cell as the candidate based on the configuration parameters.

FIG. 29 shows example, representative acts or steps which may be performed by the wireless access donor node 22-26A of FIG. 26A. Act 29-1 comprises generating a signaling message comprising configuration parameters for a cell selection procedure. Act 29-2 comprises transmitting, to the wireless relay node, the signaling message to enable the wireless relay node to make a decision to select a cell as a candidate based on the configuration parameters.

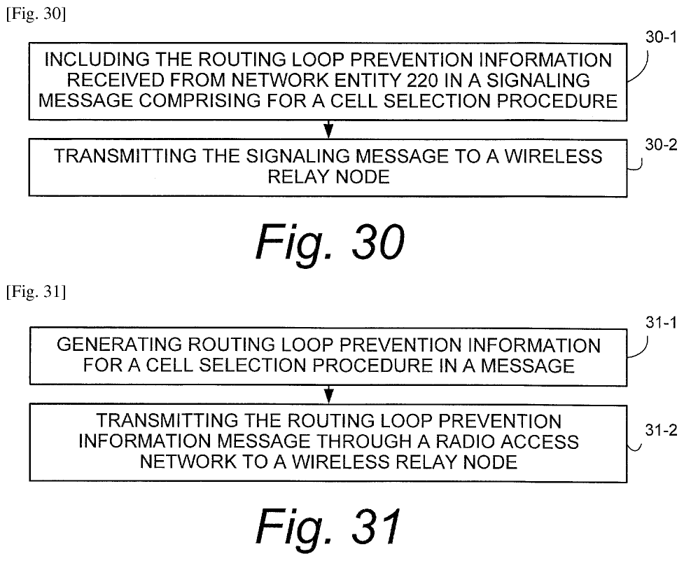

FIG. 30 shows example, representative acts or steps which may be performed by the wireless access donor node 22-26B of FIG. 26B. Act 30-1 comprises including the routing loop prevention information received from network entity 220 in a signaling message comprising for a cell selection procedure. Act 30-2 comprises transmitting, to the wireless relay node, the signaling message to enable the wireless relay node to make a decision to select a cell as a candidate based on the configuration parameters.

FIG. 31 shows example, representative acts or steps which may be performed by the network entity 220 of FIG. 26B. Act 31-1 comprises generating routing loop prevention information for a cell selection procedure in a message. Act 31-2 comprises transmitting the routing loop prevention information message through a radio access network to a wireless relay node.

In the above configurations of the example embodiments and modes, such as FIG. 26A and FIG. 26B, for example, the configuration parameters 210 may further comprise one or more radio-related parameters, such as frequency band lists, which the MT part of the IAB-node 24-26 may be directed to search on or not to search on upon an RLF.

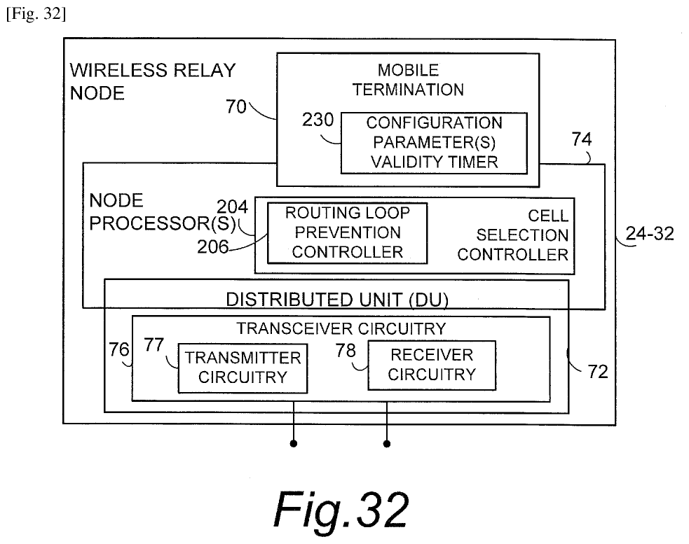

Moreover, in the foregoing example embodiments and modes such as FIG. 26A and FIG. 26B, validity of the configuration parameters 210 may be limited in time. In other words, for example, once configured, the configuration parameters 210 may be valid within a (pre)configured time period. The MT part of an IAB-node such as IAB node 24-26 may start a timer, e.g., configuration parameter(s) validity timer 230 as shown in FIG. 32, and may invalidate the configuration parameters upon the timer expiring. In one example implementation, the timer 230 is started when the configuration parameters are configured. In another example implementation, the timer 230 is started when an event (such as an RLF) triggering the cell selection procedure occurs. The value of the timer 230 may be pre-configured or configured by a network node (a parent IAB-node, an IAB-donor, or any other network entity) by dedicated signaling (e.g. RRC, F1-AP) or broadcast signaling (e.g. system information (MIB, SIB1 or other SJB(s))). In addition, a stored set of configuration parameters may become invalid when a new set of configuration parameters is received.

Preventing Routing Loops in Cell Selection: Using System Information

FIG. 33 shows an example embodiment and mode wherein the same issue of “routing loops” is addressed by an alternative approach, e.g., using system information. In the example embodiment and mode of FIG. 33, a distributed unit 72 of each IAB-node, such as IAB node 24-33, may broadcast system information (SI) comprising a list of identifiers to identify the (grand)parent cells/nodes located on the upstream path of the SI-broadcasting IAB-node, in addition to a cell/node identification of its own. FIG. 33 particularly shows that distributed unit 72 of IAB node 24-33 includes parent node-identifying system information generator 240 which includes, in the system information broadcast by IAB node 24-33, the list of identifiers to identify the (grand)parent cells/nodes located on the upstream path. In the example embodiment of FIG. 33, system information in which the parent node list is included may comprise synchronization signals (e.g. PSS/SSS), Physical Broadcast Channel (PBCH), Physical Downlink Control Channel (PDCCH), MIB, SIB1, other SIB(s) or any combination of one or more thereof.

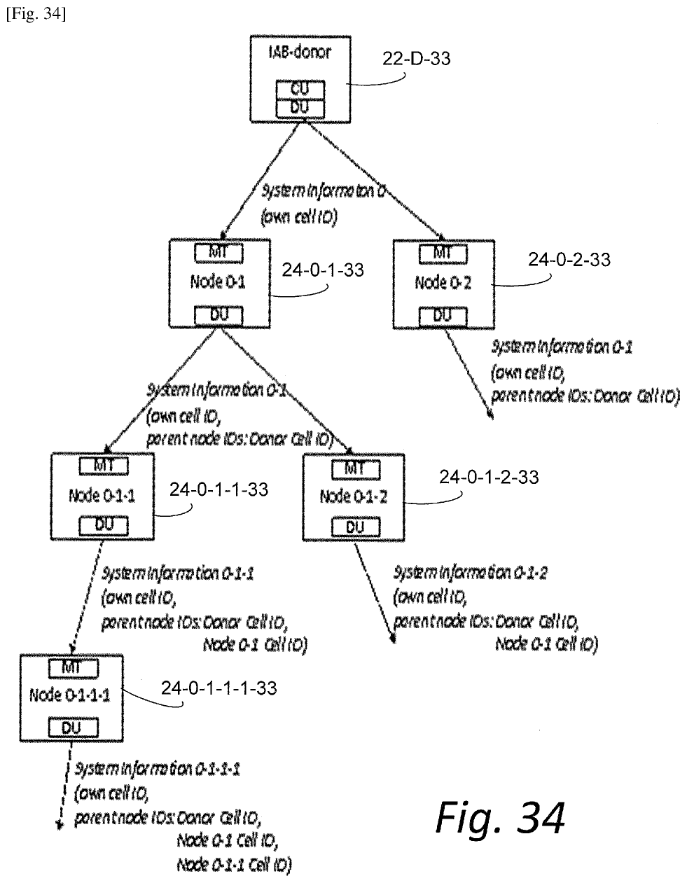

Operation of the example embodiment and mode of FIG. 33 is illustrated in FIG. 34.

FIG. 34 shows a telecommunications system comprising wireless access donor node 22-D-33, IAB node 24-0-1-33; IAB node 24-0-2-33; IAB node 24-0-1-1-33; IAB node 24-0-1-2-33; and IAB node 24-0-1-1-1-33. Each of the IAB nodes 24-33 of FIG. 34 include a mobile termination unit 70 and a distributed unit 72, with the distributed unit 72 including the aforementioned parent node-identifying system information generator 240.

FIG. 34 illustrates an example operation and mode of the example embodiment and mode of FIG. 33. First, the DU part of an IAB-donor may broadcast its own cell/node identification (e.g. PCI, CellIdentity(s), or other identification(s)) via system information (System Information 0 in FIG. 34).

Next in FIG. 34, two child nodes, IAB node 24-0-1-33 and IAB node 24-0-2-33 of FIG. 34, attach to the relay network. The two nodes IAB node 24-0-1-33 and IAB node 24-0-2-33 are in RRC_IDLE or RRC_INACTIVE state, acquiring the system information broadcast from the IAB-donor 22-D-33, and then performing the RRC connection setup procedure (as previously disclosed). During the system information acquisition, the two nodes IAB node 24-0-1-33 and IAB node 24-0-2-33 may obtain the cell/node identification of the IAB-donor 22-D-33. In a case that some of the two child nodes have already been in RRC_CONNECTED state and handover to the IAB-donor, the system information (at least some essential parts including at least the cell identification of a target cell (i.e. the TAB-donor)) may be provided to the nodes TAB node 24-0-1-33 and IAB node 24-0-2-33 by dedicated signaling (e.g. RRCReconfiguration message) before or after the handover.

After establishing an RRC connection, followed by F1-AP setting up their respective DU parts, each of the nodes IAB node 24-0-1-33 and IAB node 24-0-2-33 may start broadcasting its own system information. In the example embodiment of FIG. 34, this system information may include its own cell/node identification and may further include a list of cell/node identifications for parent nodes. For example, the DU part of IAB node 24-33-0-1-33 may broadcast system information (System Information 0-1) comprising the cell/node identification of Node 24-0-1-33 and a list of parent cell identification including the cell/node identification for the IAB-donor 22-D-33.

Next in FIG. 34, other two nodes, Node 24-0-1-1-33 and Node 24-0-1-2-33, may attach to the relay network via Node 24-0-1-33. Each of Node 24-0-1-1-33 and Node 24-0-1-2-33 perform the same action(s) as Node 24-0-1-33 or Node 24-0-2-33. In this case the system information (System Information 0-1) additionally includes the list of cell/node identifications for the parent nodes of Node 24-0-1-33 (e.g., includes the identification of the IAB-donor 22-D-33).

When broadcasting system information (System Information 0-1-1 and System Information 0-1-2, respectively), the Node 24-0-1-1-33 and Node 24-0-1-2-33 may compose a list comprising the parent cell identifications received from Node 24-0-1-33 and the cell identification of Node 24-0-1-33. Similarly, any (grand)child node attaching to the relay network may perform the same acts.

In the operation and mode described above, it is assumed that the MT part of an IAB-node informs the collocated DU part of necessary information, e.g. parent node identifications, received in the system information.

When an IAB-node detects a radio link failure (RLF) on its upstream radio link, the MT part of the IAB-node may initiate the cell selection procedure as described in the previous embodiments, and determine suitability of any discovered cells by acquiring system information (at least synchronization signals, MIB and SIB1, possibly other SIB(s)). In the operation and mode of the example embodiment of FIG. 34, the MT part of the IAB-node may decode the system information to ensure that the selected cell is not served by a child node of its own. In order to do this, the MT part of the IAB-node may examine the list of parent node identifications included in the system information and check if its own cell/node identification is in the list. If the check is positive, the MT part of the IAB-node may determine the selected cell served by its own child node and therefore attempt to look for other cells. Otherwise, the MT part of the IAB-node may examine other parameters in the system information, such as barring status, and may further proceed to the RRC reestablishment procedure as disclosed earlier.

In another example operation and mode, a different type of identifications may be used for the list of identifiers identifying (grand)parent nodes to be included in the system information. For example, Physical Cell IDs (PCIs), NR Cell Identities (CellIdentitys or NCIs), NR Cell Global Identifiers (NCGIs), gNB identifiers (gNB IDs), Global gNB identifiers, gNB-ID (specified in 3GPP TS 38.473) or any other identifies to identify cells/nodes may be used.

At least some of the example operations and modes disclosed above in the example embodiment of FIG. 33 and FIG. 34 assume that each IAB-node is implemented in such a way that the identifications of (grand)parent nodes on its upstream path towards an IAB-donor are retrieved from received system information by the MT part and transferred to the collocated DU part, where the identifications are further used in the system information that the collocated DU part may broadcast. For example, the cell selection routing loop prevention controller 206 of the Integrated Access and Backhaul (IAB) node may include or have access to the upstream node identifications.

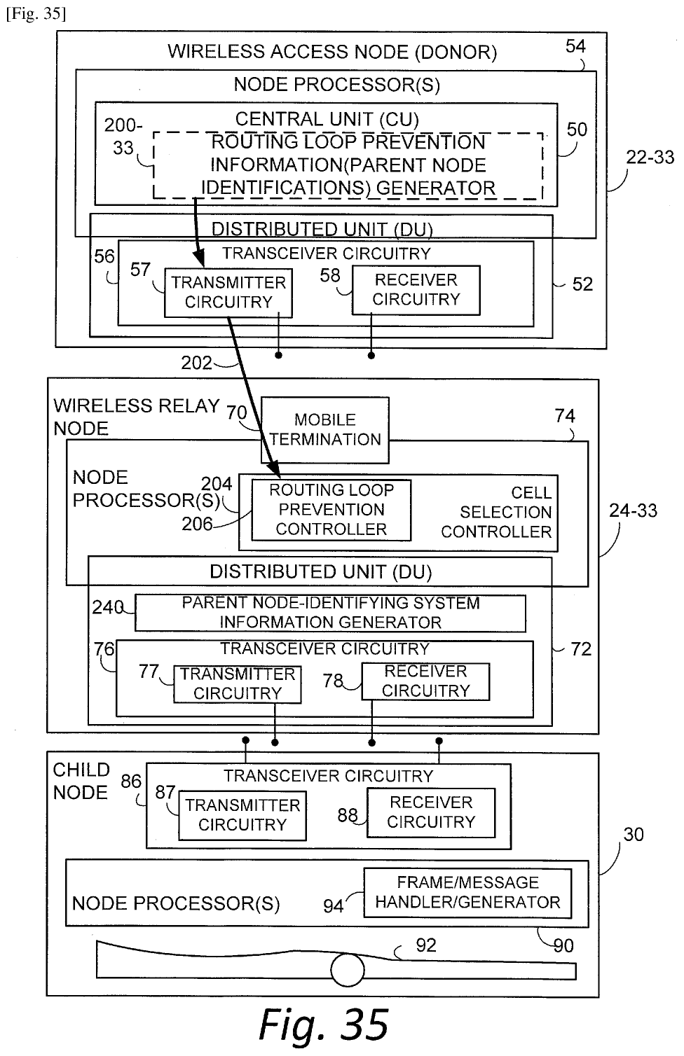

In an alternative approach shown in FIG. 35, the IAB-donor 22-D-33 (or any other network entity) may configure each IAB-node with a set of parent node identifications to be broadcasted by the IAB-node. In this case, during IAB-node being attached to the IAB-donor, the set of parent node identifications may be configured by an RRC message (e.g. RRCReconfiguration message) or an F1-AP message. FIG. 33 shows such optional alternative by the routing loop prevention information generator takes the form of a parent node identifications generator 200-33.

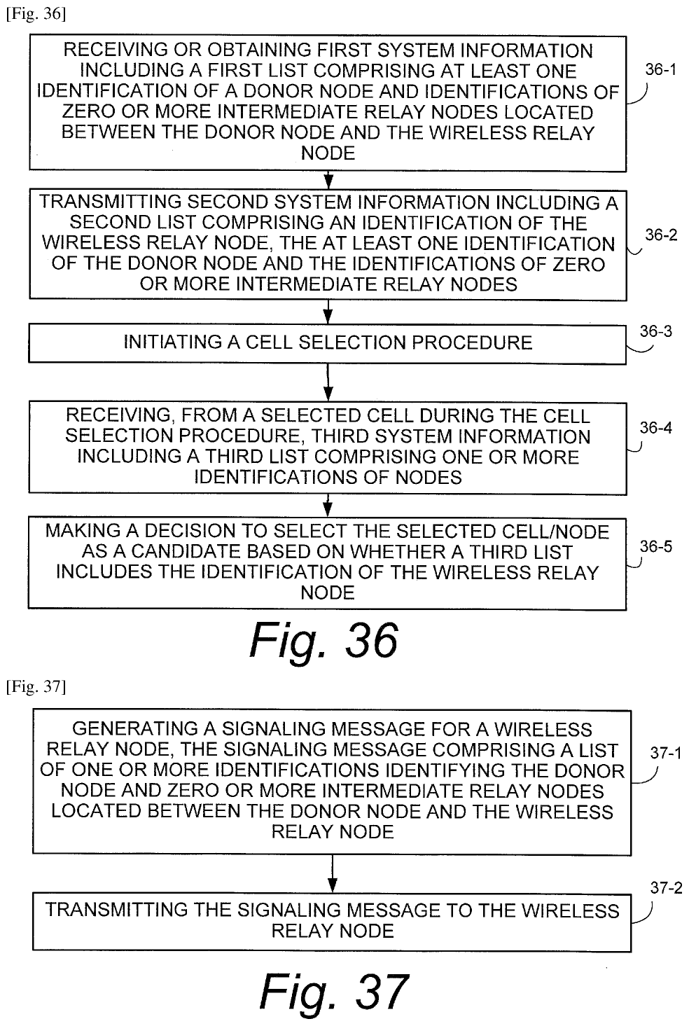

FIG. 36 shows example, representative acts of steps that may be performed by an IAB node 24-33 of the example embodiment and mode of FIG. 33-FIG. 35. Act 36-1 comprises receiving or obtaining first system information including a first list comprising at least one identification of a donor node and identifications of zero or more intermediate relay nodes located between the donor node and the wireless relay node. Act 36-2 comprises transmitting second system information including a second list comprising an identification of the wireless relay node, the at least one identification of the donor node and the identifications of zero or more intermediate relay nodes. Act 36-3 comprises initiating a cell selection procedure. Act 36-4 comprises, in the cell selection procedure, further receiving, from a selected cell during the cell selection procedure, third system information including a third list comprising one or more identifications of nodes. Act 36-5 comprises, in the cell selection procedure, making a decision to select the selected cell/node as a candidate based on whether a third list includes the identification of the wireless relay node.

FIG. 37 shows example, representative acts of steps that may be performed by a wireless access donor node such as node 22-D-33 of the example embodiment and mode of FIG. 33-FIG. 35. Act 37-1 comprises generating a signaling message for a wireless relay node, the signaling message comprising a list of one or more identifications identifying the donor node and zero or more intermediate relay nodes located between the donor node and the wireless relay node. Act 37-2 comprises transmitting the signaling message to the wireless relay node. As understood from the foregoing, the list of one or more identifications is configured to enable the wireless relay node to make a decision to select a cell/node as a candidate during a cell selection procedure.

It should be understood that the various foregoing example embodiments and modes may be utilized in conjunction with one or more example embodiments and modes described herein. For example, the routing loop prevention information embodiments described herein may be utilized in conjunction with one or more of the earlier described example embodiments and modes.

The system of IAB is expected to be reliable and robust against various kinds of possible failures. The technology disclosed herein thus provides methods and procedures to deal with a radio link failure on the backhaul link.

The technology disclosed herein provides methods for handling cases where an IAB node loses the connection to the network due to a radio link failure. Example, non-limiting methods and features include:
The IAB node transmits to its child nodes/UEs information representing the radio condition of its upstream link.
The child nodes/UEs decide, based on the received information, whether or not to stay on the current serving IAB node or reselect another cell/TAB node.
The child nodes/UEs may wait for a designated duration before making the decision, expecting that the serving IAB node recovers the upstream radio link during the duration.
The child nodes/UEs may be configured with a conditional handover that allows an autonomous handover when its parent node suffered from a designated radio condition on its upstream link.
The child nodes/UEs may be configured with multiple signaling paths and may report a designated radio condition occurring on one of the paths using one of the remaining paths.
The donor node may configure an IAB node with a list of cell identities that the IAB node is allowed to select upon RLF.
The donor node may configure an IAB node with a list of cell identities that the IAB node is not allowed to select upon RLF.
Each IAB node may broadcast in system information a set of node identifications for its (grand)parent nodes.

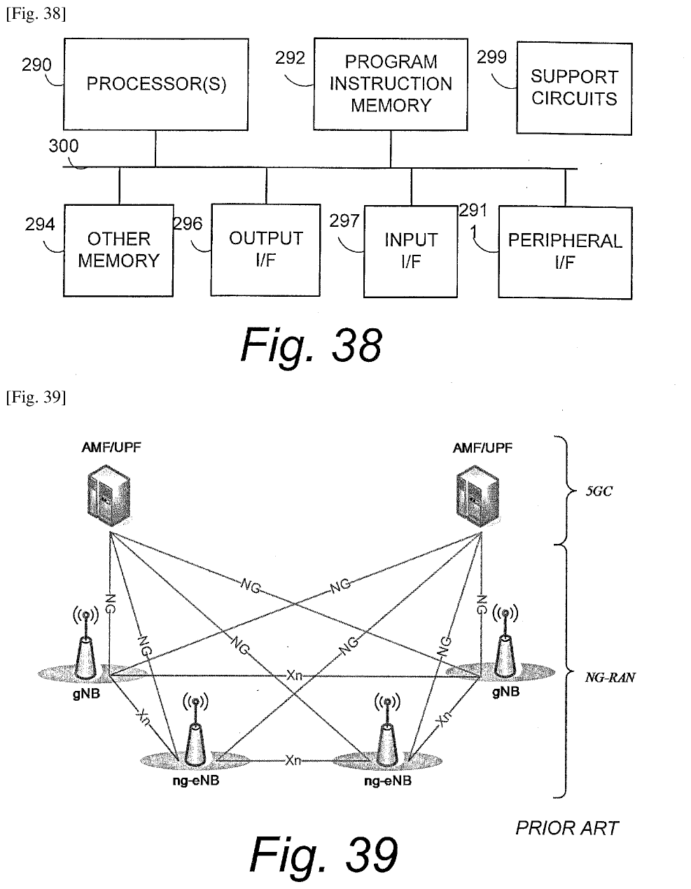

Certain units and functionalities of the systems 20 may be implemented by electronic machinery. For example, electronic machinery may refer to the processor circuitry described herein, such as node processor(s) 54, relay node processor(s) 74, and node processor(s) 90. Moreover, the term “processor circuitry” is not limited to mean one processor, but may include plural processors, with the plural processors operating at one or more sites. Moreover, as used herein the term “server” is not confined to one server unit, but may encompasses plural servers and/or other electronic equipment, and may be co-located at one site or distributed to different sites. With these understandings, FIG. 38 shows an example of electronic machinery, e.g., processor circuitry, as comprising one or more processors 290, program instruction memory 292; other memory 294 (e.g., RAM, cache, etc.); input/output interfaces 296 and 297, peripheral interfaces 298; support circuits 299; and busses 300 for communication between the aforementioned units. The processor(s) 290 may comprise the processor circuitries described herein, for example, node processor(s) 54, relay node processor(s) 74, and node processor(s) 90.

An memory or register described herein may be depicted by memory 294, or any computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory. The support circuits 299 are coupled to the processors 290 for supporting the processor in a conventional manner. These circuits include cache, power supplies, clock circuits, input/output circuitry and subsystems, and the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

Moreover, each functional block or various features of the wireless terminal 30 and Integrated Access and Backhaul (IAB) nodes employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves basic function of a radio access network, e.g., methods and procedures to deal with problematic conditions on a backhaul link, such as radio link failure (RLF), for example, and avoiding routing loop problems when performing a cell selection procedure, e.g., after a radio link failure (RLF).

The technology disclosed herein encompasses one or more of the following non-limiting, non-exclusive example embodiments and modes:

Example Embodiment 1: A wireless relay node comprising:

receiver circuitry configured to receive routing loop prevention information;

processor circuitry configured to perform a cell selection procedure using the routing loop prevention information and thereby avoid selecting a cell of a child or grandchild node.

Example Embodiment 2: The wireless relay node of Example Embodiment 1, wherein the receiver circuitry is configured to receive, from a donor node, a signaling message comprising configuration parameters for the cell selection procedure, and wherein the processor circuitry is configured to: make a decision to select a cell as a candidate based on the configuration information.

Example Embodiment 3: The wireless relay node of Example Embodiment 2, wherein the processor circuitry is configured to initiate the cell selection procedure in a case that the receiver circuitry detects a radio link failure (RLF).

Example Embodiment 4: The wireless relay node of Example Embodiment 2, wherein the configuration parameters comprise a whitelist including identifications of cells/nodes that the wireless terminal is allowed to camp on, and during the cell selection procedure the processor circuitry is further configured to consider any of the cells as candidates.

Example Embodiment 5: The wireless relay node of Example Embodiment 2, wherein the configuration parameters comprise a blacklist including identifications of cells/nodes that the wireless terminal is not allowed to camp on, and during the cell selection procedure the processor circuitry is further configured not to consider any of the cells as candidates.

Example Embodiment 6: The wireless relay node of Example Embodiment 2, wherein the signaling message comprises a Radio Resource Control (RRC) message.

Example Embodiment 7: The wireless relay node of Example Embodiment 2, wherein the signaling message comprises an F1 application protocol (F1-AP) message.

Example Embodiment 8: The wireless relay node of Example Embodiment 2, wherein the configuration parameters are associated with at least one timer and are valid within a timer duration.

Example Embodiment 9: The wireless relay node of Example Embodiment 8, wherein the timer starts upon reception of the signaling message.

Example Embodiment 10: The wireless relay node of Example Embodiment 8, wherein the timer starts upon initiating the cell selection procedure.

Example Embodiment 11: The wireless relay node of Example Embodiment 1: wherein:
the receiver circuitry is configured to receive first system information including a first list comprising at least one identification of a donor node and identifications of zero or more intermediate relay nodes located between the donor node and the wireless relay node;
the wireless relay node further comprises transmitter circuitry configured to transmit second system information including a second list comprising an identification of the wireless relay node, the at least one identification of the donor node, and the identifications of zero or more intermediate relay nodes;
the processor circuitry is configured to initiate a cell selection procedure;
wherein the receiver circuitry is further configured to receive, from a selected cell during the cell selection procedure, third system information including a third list comprising one or more identifications of nodes; and
the processor circuitry is further configured to make a decision to select the selected cell/node as a candidate based on whether a third list includes the identification of the wireless relay node.

Example Embodiment 12: The wireless relay node of Example Embodiment 11, wherein the cell selection procedure is initiated in a case that the receiver circuitry detects a radio link failure (RLF).

Example Embodiment 13: The wireless relay node of Example Embodiment 11, wherein the processor circuitry is configured to consider the selected cell/node as the candidate in a case that the third list does not include the identification of the wireless relay node.

Example Embodiment 14: The wireless relay node of Example Embodiment 11, wherein the processor circuitry is configured to consider the selected cell/node as barred (not a candidate) in a case that the third list includes the identification of the wireless relay node.

Example Embodiment 15: The wireless relay node of Example Embodiment 11, wherein the selected cell is served by a parent node, the parent relay node being either the donor node or an intermediate relay node directly communicating with the wireless relay node.

Example Embodiment 16: The wireless relay node of Example Embodiment 11, wherein the second list is configured via a dedicated signaling message, the dedicated signaling message being sent by the donor node.

Example Embodiment 17: The wireless relay node of Example Embodiment 11, wherein the identifications included in the first, second or third list are cell identifications.

Example Embodiment 18: The wireless relay node of Example Embodiment 11, wherein the identifications included in the first, second or third list are node identifications.

Example Embodiment 19: A donor node comprising:
processor circuitry configured to include routing loop prevention information for a cell selection procedure in a routing loop prevention information message;
transmitter circuitry configured to transmit the routing loop prevention information message to a wireless relay node.

Example Embodiment 20: The donor node of Example Embodiment 19, wherein the processor circuitry is configured to generate a signaling message comprising configuration parameters for a cell selection procedure, and wherein the transmitter circuitry is configured to transmit, to the wireless relay node, the signaling message, and wherein the configuration parameters are configured whereby a decision by the wireless relay node to select a cell as a candidate is determined based on the configuration parameters.

Example Embodiment 21: The donor node of Example Embodiment 19, wherein the cell selection procedure is initiated by the wireless relay node in a case that the wireless relay node detects a radio link failure (RLF).

Example Embodiment 22: The donor node of Example Embodiment 20, wherein the configuration parameters comprise a whitelist including identifications of cells/nodes that the wireless relay node is allowed to camp on, the whitelist being configured to enable the wireless relay node to consider any of the cells as candidates during the cell selection procedure.

Example Embodiment 23: The donor node of Example Embodiment 20, wherein the configuration parameters comprise a blacklist including identifications of cells/nodes that the wireless relay node is not allowed to camp on, the blacklist being configured to enable the wireless relay node not to consider any of the cells as candidates during the cell selection procedure.

Example Embodiment 24: The donor node of Example Embodiment 20, wherein the signaling message comprises a Radio Resource Control (RRC) message.

Example Embodiment 25: The donor node of Example Embodiment 20, wherein the signaling message comprises an F1 application protocol (F1-AP) message.

Example Embodiment 26: The donor node of Example Embodiment 20, wherein the configuration parameters are associated with at least one timer and are valid within a timer duration wherein the configuration parameters are associated with at least one timer and are valid within a timer duration.

Example Embodiment 27: The donor node of Example Embodiment 26, wherein the timer is to start upon the wireless relay node receiving the signaling message.

Example Embodiment 28: The donor node of Example Embodiment 27, wherein the timer is to start upon the wireless relay node initiating the cell selection procedure.

Example Embodiment 29: The donor node of Example Embodiment 19, wherein:
the processor circuitry is configured to generate a signaling message for a wireless relay node, the signaling message comprising a list of one or more identifications identifying the donor node and zero or more intermediate relay nodes located between the donor node and the wireless relay node;
the transmitter circuitry is configured to transmit the signaling message to the wireless relay node;
the list of one or more identifications is configured to enable the wireless relay node to make a decision to select a cell/node as the candidate during the cell selection procedure.

Example Embodiment 30: The donor node of Example Embodiment 29, wherein the cell selection procedure is initiated by the wireless relay node in a case that the wireless relay node detects a radio link failure (RLF).

Example Embodiment 31: The donor node of Example Embodiment 29, wherein the list of one or more identifications is configured to enable the wireless relay node to consider a cell/node selected during the cell selection procedure as a candidate in a case that the list of one or more identifications does not include the identification of the wireless relay node.

Example Embodiment 32: The donor node of Example Embodiment 29, wherein the list of one or more identifications is configured to enable the wireless relay node to consider a cell/node selected during the cell selection procedure as barred (not a candidate) in a case that the list of one or more identifications includes the identification of the wireless relay node.

Example Embodiment 33: The donor node of Example Embodiment 29, wherein the one or more identifications are cell identifications.

Example Embodiment 34: The donor node of Example Embodiment 29, wherein the one or more identifications are node identifications.

Example Embodiment 35: A method for a wireless relay node comprising:
receiving routing loop prevention information;
using the routing loop prevention information in a cell selection procedure to select a cell as a candidate.

Example Embodiment 36: The method of Example Embodiment 35, further comprising:
receiving, a signaling message comprising configuration parameters for the cell selection procedure;
initiating the cell selection procedure and in the cell selection procedure making a decision to select a cell as the candidate based on the configuration parameters.

Example Embodiment 37: The method of Example Embodiment 36, further comprising initiating the cell selection upon or after detecting a radio link failure (RLF).

Example Embodiment 38: The method of Example Embodiment 36, wherein the configuration parameters comprise a whitelist including identifications of cells/nodes that the wireless relay node is allowed to camp on, and during the cell selection procedure any of the cells are considered as candidates.

Example Embodiment 39: The method of Example Embodiment 36, wherein the configuration parameters comprise a blacklist including identifications of cells/nodes that the wireless relay node is not allowed to camp on, and during the cell selection procedure none of the cells are considered as candidates.

Example Embodiment 40: The method of Example Embodiment 36, wherein the signaling message comprises a Radio Resource Control (RRC) message.

Example Embodiment 41: The method of Example Embodiment 36, wherein the signaling message comprises an F1 application protocol (F1-AP) message.

Example Embodiment 42: The method of Example Embodiment 36, wherein the configuration parameters are associated with at least one timer and are valid within a timer duration.

Example Embodiment 43: The method of Example Embodiment 42, wherein the timer starts upon reception of the signaling message.

Example Embodiment 44: The method of Example Embodiment 42, wherein the timer starts upon initiating the cell selection procedure.

Example Embodiment 45: The method of Example Embodiment 35, further comprising:
receiving first system information including a first list comprising at least one identification of a donor node and identifications of zero or more intermediate relay nodes located between the donor node and the wireless relay node;
transmitting second system information including a second list comprising an identification of the wireless relay node, the at least one identification of the donor node and the identifications of zero or more intermediate relay nodes;
initiating a cell selection procedure, and in the cell selection procedure:
further receiving, from a selected cell during the cell selection procedure, third system information including a third list comprising one or more identifications of nodes and;
making a decision to select the selected cell/node as a candidate based on whether a third list includes the identification of the wireless relay node.

Example Embodiment 46: The method of Example Embodiment 45, further comprising initiating the cell selection upon or after detecting a radio link failure (RLF).

Example Embodiment 47: The method of Example Embodiment 45, further comprising considering the selected cell/node as a candidate in a case that the third list does not include the identification of the wireless relay node.

Example Embodiment 48: The method of Example Embodiment 45, further comprising considering the selected cell/node as barred (not a candidate) in a case that the third list includes the identification of the wireless relay node.

Example Embodiment 49: The method of Example Embodiment 45, wherein the selected cell is served by a parent node, the parent relay node being either the donor node or an intermediate relay node directly communicating with the wireless relay node.

Example Embodiment 50: The method of Example Embodiment 45, wherein the second list is configured via a dedicated signaling message, the dedicated signaling message being sent by the donor node.

Example Embodiment 51: The method of Example Embodiment 45, wherein the identifications included in the first, second or third list are cell identifications.

Example Embodiment 52: The method of Example Embodiment 45, wherein the identifications included in the first, second or third list are node identifications.

Example Embodiment 53: A method for a donor node comprising:
including routing loop prevention information in a routing loop prevention information message for use in a cell selection procedure;
transmitting the routing loop prevention information message to a wireless relay node.

Example Embodiment 54: The method of Example Embodiment 53, further comprising:
generating a signaling message comprising configuration parameters for a cell selection procedure;
transmitting, to the wireless relay node, the signaling message to enable the wireless relay node to make a decision to select a cell as a candidate based on the configuration parameters.

Example Embodiment 55: The method of Example Embodiment 54, further comprising initiating the cell selection procedure in a case that the wireless relay node detects a radio link failure (RLF).

Example Embodiment 56: The method of Example Embodiment 54, wherein the configuration parameters comprise a whitelist including identifications of cells/nodes that the wireless relay node is allowed to camp on, the whitelist being configured to enable the wireless relay node to consider any of the cells as candidates during the cell selection procedure.

Example Embodiment 57: The method of Example Embodiment 54, wherein the configuration parameters comprise a blacklist including identifications of cells/nodes that the wireless relay node is not allowed to camp on, the blacklist being configured to enable the wireless relay node not to consider any of the cells as candidates during the cell selection procedure.

Example Embodiment 58: The method of Example Embodiment 54, wherein the signaling message comprises a Radio Resource Control (RRC) message.

Example Embodiment 59: The method of Example Embodiment 54, wherein the signaling message comprises an F1 application protocol (F1-AP) message.

Example Embodiment 60: The method of Example Embodiment 54, wherein the configuration parameters are associated with at least one timer and are valid within a timer duration.

Example Embodiment 61: The method of Example Embodiment 60, wherein the timer is to start upon the wireless relay node receiving the signaling message.

Example Embodiment 62: The method of Example Embodiment 60, wherein the timer is to start upon the wireless relay node initiating the cell selection procedure.

Example Embodiment 63: The method of Example Embodiment 53, further comprising:
generating a signaling message for a wireless relay node, the signaling message comprising a list of one or more identifications identifying the donor node and zero or more intermediate relay nodes located between the donor node and the wireless relay node;
transmitting the signaling message to the wireless relay node;
wherein the list of one or more identifications is configured to enable the wireless relay node to make a decision to select a cell/node as a candidate during a cell selection procedure.

Example Embodiment 64: The method of Example Embodiment 63, wherein the cell selection procedure is initiated in a case that the wireless relay node detects a radio link failure (RLF).

Example Embodiment 65: The method of Example Embodiment 63, wherein the list of one or more identifications is configured to enable the wireless relay node to consider a cell/node selected during the cell selection procedure as a candidate in a case that the list of one or more identifications does not include the identification of the wireless relay node.

Example Embodiment 66: The method of Example Embodiment 63, wherein the list of one or more identifications is configured to enable the wireless relay node to consider a cell/node selected during the cell selection procedure as barred (not a candidate) in a case that the list of one or more identifications includes the identification of the wireless relay node.

Example Embodiment 67: The method of Example Embodiment 63, wherein the one or more identifications are cell identifications.

Example Embodiment 68: The method of Example Embodiment 63, wherein the one or more identifications are node identifications.

Example Embodiment 69: A server entity of a telecommunications network comprising:
processor circuitry configured to generate routing loop prevention information for a cell selection procedure in a message;
an interface configured to transmit the routing loop prevention information message through a radio access network to a wireless relay node.

Example Embodiment 70: A method in a server entity of a telecommunications network, the method comprising:
generating routing loop prevention information for a cell selection procedure in a message;
transmitting the routing loop prevention information message through a radio access network to a wireless relay node.

Example Embodiment 71: A wireless relay node comprising: receiver circuitry configured to receive routing loop prevention information; processor circuitry configured to perform a cell selection procedure based on the routing loop prevention information; wherein the routing loop prevention information comprises configuration parameters to be used to avoid selecting a cell of a child or grandchild node during the cell selection procedure.

Example Embodiment 72: The wireless relay node of Example Embodiment 71, wherein the configuration parameters comprise a whitelist including identities of cells that the wireless terminal is allowed to camp on, and the processor circuitry is further configured to consider any of the cells as candidates.

Example Embodiment 73; The wireless relay node of Example Embodiment 71, wherein the configuration parameters comprise a blacklist including identities of cells that the wireless terminal is not allowed to camp on, and the processor circuitry is further configured not to consider any of the cells as candidates.

Example Embodiment 74: The wireless relay node of Example Embodiment 71, wherein the configuration parameters comprise zero or more identities of cells, and the processor circuitry is further configured not to consider a cell as a candidate, in a case that the cell broadcasts, in first system information, the configuration parameters including an identity of a cell served by the wireless relay node as a part of the zero or more identities of cells.

Example Embodiment 75: The wireless relay node of Example Embodiment 74, wherein the wireless relay node further comprises transmitter circuitry configured to transmit second system information comprising an identity of a cell served by the wireless relay node and the identities of zero or more cells.

Example Embodiment 76: A donor node comprising: processor circuitry configured to include routing loop prevention information in a message; transmitter circuitry configured to transmit the routing loop prevention information message to a wireless relay node; wherein the routing loop prevention information comprises configuration parameters to be used by the wireless relay node during a cell selection procedure to avoid selecting a cell served by the wireless relay node's child or grandchild node.

Example Embodiment 77: The donor node of Example Embodiment 76, wherein the configuration parameters comprise a whitelist including identities of cells that the wireless relay node is allowed to camp on, the whitelist being configured to enable the wireless relay node to consider any of the cells as candidates.

Example Embodiment 78: The donor node of Example Embodiment 76, wherein the configuration parameters comprise a blacklist including identities of cells that the wireless relay node is not allowed to camp on, the blacklist being configured to enable the wireless relay node not to consider any of the cells as candidates.

Example Embodiment 79: The donor node of Example Embodiment 78, wherein the configuration parameters comprise zero or more identities of cells, the configuration parameters instructing the wireless relay node not to consider a cell as a candidate, in a case that the cell broadcasts, in first system information, the configuration parameters including an identity of a cell served by the wireless relay node as a part of the zero or more identities of cells.

Example Embodiment 80: A method for a wireless relay node comprising: receiving routing loop prevention information; performing a cell selection procedure based on the routing loop prevention information; wherein the routing loop prevention information comprises configuration parameters to be used to avoid selecting a cell of a child or grandchild node during the cell selection procedure.

Example Embodiment 81: The method of Example Embodiment 80, wherein the configuration parameters comprise a whitelist including identities of cells that the wireless relay node is allowed to camp on, and any of the cells are considered as candidates.

Example Embodiment 82: The method of Example Embodiment 80, wherein the configuration parameters comprise a blacklist including identities of cells that the wireless relay node is not allowed to camp on, and none of the cells are considered as candidates.

Example Embodiment 83: The method of Example Embodiment 80, wherein the configuration parameters comprise zero or more identities of cells, and a cell is not considered as a candidate, in a case that the cell broadcasts, in first system information, the configuration parameters including an identity of a cell served by the wireless relay node as a part of the zero or more identities of cells.

Example Embodiment 84: The method of Example Embodiment 83, further comprising transmitting second system information comprising an identity of a cell served by the wireless relay node and the identities of zero or more cells.

Example Embodiment 85: A method for a donor node comprising: including routing loop prevention information in a message; transmitting the routing loop prevention information message to a wireless relay node; wherein the routing loop prevention information comprises configuration parameters to be used by the wireless relay node during a cell selection procedure to avoid selecting a cell served by the wireless relay node's child or grandchild node.

Example Embodiment 86: The method of Example Embodiment 85, wherein the configuration parameters comprise a whitelist including identities of cells that the wireless relay node is allowed to camp on, the whitelist being configured to enable the wireless relay node to consider any of the cells as candidates.

Example Embodiment 87: The method of Example Embodiment 85, wherein the configuration parameters comprise a blacklist including identities of cells that the wireless relay node is not allowed to camp on, the blacklist being configured to enable the wireless relay node not to consider any of the cells as candidates.

Example Embodiment 88: The method of Example Embodiment 85, wherein the configuration parameters comprise zero or more identities of cells, the configuration parameters instructing the wireless relay node not to consider a cell as a candidate, in a case that the cell broadcasts, in first system information, the configuration parameters including an identity of a cell served by the wireless relay node as a part of the zero or more identities of cells.

One or more of the following documents may be pertinent to the technology disclosed herein (all of which are incorporated herein by reference in their entirety):
R2-1816509 Selection of Parent for IAB-Node vivo
R2-1816561 JAB node selection and reselection in RRC_IDLE Ericsson
R2-1816562 JAB node relocation Ericsson
R2-1816564 Minimizing CN functionalities for IAB network Ericsson
R2-1816567 Network slicing in IAB networks Ericsson
R2-1816579 Suspension of Transmission upon Failure of Backhaul links Ericsson
R2-1816580 Setup Procedure for the Adaptation Layer of an JAB Network Ericsson
R2-1817073 Route management in JAB Sony
R2-1817074 Open issues related to TAB power on procedure Sony
R2-1817169 Parent node selection for JAB access Lenovo, Motorola Mobility
R2-1817170 RLF in backhaul link Lenovo, Motorola Mobility
R2-1817271 Topology Management for Spanning Tree topologies Nokia, Nokia Shanghai Bell
R2-1817411 Discussion on backhaul bearer setup in TAB network ZTE Corporation
R2-1817418 Discussion on JAB node discovery and selection ZTE Corporation
R2-1817419 Consideration on Routing in IAB ZTE Corporation
R2-1817520 Topology in IAB system Lenovo, Motorola Mobility
R2-1817543 Which cell/IAB node support child IAB access Lenovo, Motorola Mobility
R2-1817573 Consideration of RLF recovery in IAB Kyocera
R2-1817616 Discovery and measurements for JAB Nokia, Nokia Shanghai Bell
R2-1817699 Route Adaptation Upon Backhaul Failure Intel Corporation
R2-1817716 Text proposal for Route Adaptation Upon Backhaul Failure Intel Corporation
R2-1817775 Route selection method for architecture 1a Huawei Technologies France
R2-1817836 CP signalling transmission in IAB NSA Futurewei Technologies
R2-1817906 JAB bearer mapping decisions Huawei Technologies France
R2-1817931 QoS parameters for JAB QoS handling Huawei Technologies France
R2-1817990 Service Interruption Minimization during Topology Adaptation ITRI
R2-1818231 Consideration on backhaul link enhancement for JAB LG Electronics France
R2-1818292 Discussion on cell reselection of JAB nodes LG Electronics Inc.
R2-1818336 Support of Multiple connectivity for IAB nodes Futurewei Technologies
R2-1818367 Handling of the RLF on wireless backhaul link LG Electronics Inc.
R2-1818377 JAB routing and topology management for Architecture 1a Nokia, Nokia Shanghai Bell
R2-1818415 Access Control for IAB node LG Electronics Inc.
R2-1818745 TP QoS parameters for TAB QoS handling Huawei Technologies France
R2-1818746 Route Adaptation Upon Backhaul Failure Intel Corporation
R2-1818764 TP QoS parameters for IAB QoS handling Huawei Technologies France
R2-1818765 Route Adaptation Upon Backhaul Failure Intel Corporation
R2-1818790 TP on QoS parameters for JAB QoS handling Huawei Technologies France

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

What is claimed is:

1. A wireless relay node comprising:
receiver circuitry configured to receive routing loop prevention information;
processor circuitry configured to perform a cell selection procedure based on the routing loop prevention information; wherein
the routing loop prevention information comprises a blacklist comprising one or more cell identities identifying one or more cells served by one or more child/grandchild nodes of the wireless relay node.

2.-18. (canceled)

19. The wireless relay node of claim 1, wherein the one or more cells identified by the one or more cell identities in the blacklist are not allowed to camp on during the cell selection.

20. The wireless relay node of claim 1, wherein the routing loop prevention information further comprises a whitelist including one or more cell identities identifying one or more cells that the wireless terminal is allowed to camp on during the cell selection procedure.

21. A donor node comprising:
processor circuitry configured to generate routing loop prevention information;
transmitter circuitry configured to transmit the routing loop prevention information to a wireless relay node; wherein
the routing loop prevention information comprises a blacklist comprising one or more cell identities identifying cells served by one or more child/grandchild nodes of the wireless relay node, and;
the routing loop prevention information is used by the wireless relay node to perform a cell selection procedure.

22. The donor node of claim 21, wherein the one or more cells identified by the one or more cell identities in the blacklist are not allowed to camp on during the cell selection procedure.

23. The donor node of claim 21, wherein the routing loop prevention information comprises a whitelist including one or more cell identities identifying one or more cells that the wireless relay node is allowed to camp on during the cell selection procedure.

24. A method for a wireless relay node comprising:
receiving routing loop prevention information;
performing a cell selection procedure based on the routing loop prevention information; wherein
the routing loop prevention information comprises a blacklist comprising one or more cell identities identifying one or more cells served by one or more child/grandchild nodes of the wireless relay node.

25. The method of claim 24, wherein the one or more cells identified by the one or more cell identities in the blacklist are not allowed to camp on during the cell selection procedure.

26. The method of claim 24, wherein the routing loop prevention information further comprises a whitelist including one or more cell identities identifying one or more cells that the wireless terminal is allowed to camp on during the cell selection procedure.

27. A method for a donor node comprising:
generating routing loop prevention information;
transmitting the routing loop prevention information to a wireless relay node; wherein
the routing loop prevention information comprises a blacklist comprising one or more cell identities identifying cells served by one or more child/grandchild nodes of the wireless relay node, and;
the routing loop prevention information is used by the wireless relay node to perform a cell selection procedure.

28. The method of claim 27, wherein the one or more cells identified by the one or more cell identities in the blacklist are not allowed to camp on during the cell selection procedure.

29. The method of claim 27, wherein the routing loop prevention information further comprises a whitelist including one or more cell identities identifying one or more cells that the wireless terminal is allowed to camp on during the cell selection procedure.
